(19) United States
(12) Patent Application Publication
(10) Pub. No.: US 2013/0212021 A1
(43) Pub. Date: Aug. 15, 2013

(54) AMOUNT-EXCEEDING-CREDIT-THRESHOLD SERVICE SUBJECT TO CONDITION

(71) Applicant: BANK OF AMERICA CORPORATION, (US)

(72) Inventors: Tamara S. Kingston, Peoria, AZ (US); John Franklin Tuders, Harrisburg, NC (US); Ross Matthew Feldman, Matthews, NC (US); Marc Lance Warshawsky, Davidson, NC (US); Erik Stephen Ross, Charlotte, NC (US); Elbert Lee Whitler, Webster Groves, MO (US); Mark D. Zanzot, Huntersville, NC (US); Ketil Bjugan, Charlotte, NC (US); Scott Mastbrook, Charlotte, NC (US); William Sydney Ivey, Charlotte, NC (US); Mark Allan Nelson, Waxhaw, NC (US); Brenda Lisbeth Smyth, Fenton, MO (US); Doris Maria Garrett, Walnut Creek, CA (US); Jonathan H. Tucker, Charlttte, NC (US); Catherine Stokes Pullen, Mouth Holly, NC (US); Paul Ronald DeKoster, Matthews, NC (US)

(73) Assignee: BANK OF AMERICA CORPORATION, CHARLOTTE, NC (US)

(21) Appl. No.: 13/837,916

(22) Filed: Mar. 15, 2013

Related U.S. Application Data
(63) Continuation-in-part of application No. 13/033,510, filed on Feb. 23, 2011.
Application No. 13/033,510 is a continuation-in-part of application No. 12/879,866, filed on Sep. 10, 2010.
(60) Provisional application No. 61/416,652, filed on Nov. 23, 2010.
(60) Provisional application No. 61/436,196, filed on Jan. 26, 2011.

(51) Int. Cl. G06Q 20/40

(52) U.S. Cl. CPC G06Q 20/405
USPC 705/44

(57) ABSTRACT

In general terms, embodiments of the present invention relate to methods and apparatuses for providing an amount-exceeding-credit-threshold service subject to one or more predetermined conditions. For example, in some embodiments, a method is provided that includes: determining that an account will exceed a credit threshold associated with the account as a result of a transaction, determining that a predetermined condition is met and/or that the consent of the holder of the account is valid for the transaction, and authorizing the transaction based at least partially on receiving the consent, determining that the holder's consent is valid for the transaction, and/or determining that the predetermined condition is met.

### CROSS-REFERENCE TO RELATED APPLICATIONS

The present application is a continuation-in-part of U.S. patent application Ser. No. 13/033,510 for an “Overage Service Subject to Condition” (filed Feb. 23, 2011), which published on Mar. 15, 2012, as U.S. Patent Application Publication No. 2012/0066127, which itself is a continuation-in-part of U.S. patent application Ser. No. 12/879,866 for a “Service Participation Acknowledgement System” (filed Sep. 10, 2010). U.S. patent application Ser. No. 13/033,510 also claims the benefit of U.S. Patent Application Ser. No. 61/416,652 for “Overage Communication Systems” (filed Nov. 23, 2010) and U.S. Patent Application Ser. No. 61/436,196 for “Overage Communication Systems” (filed Jan. 26, 2011). Each of the foregoing patent applications and patent application publication is hereby incorporated by reference in its entirety.

### BACKGROUND

Financial institution customers are constantly looking for new and useful ways to better manage their finances. This is particularly so given that most of today's financial institution customers have multiple financial accounts and the consequences associated with mismanaging or forgetting about any one of them can lead to unexpected or unwanted outcomes. For example, a customer may exceed available funds in his checking account and incur a related exceeding-available-funds cost by engaging in a transaction that he mistakenly believes his account can cover. Accordingly, there is a need to provide methods and apparatuses that help financial institution customers manage their finances in ways that avoid or reduce unexpected or unwanted outcomes.

### SUMMARY OF SELECTED EMBODIMENTS OF THE PRESENT INVENTION

In light of the foregoing background, the following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

In general terms, embodiments of the present invention relate to methods and apparatuses for providing an amount-exceeding-credit threshold service subject to one or more predetermined conditions (e.g., limitations, rules, requirements, and the like). For example, in some embodiments, a holder of an account can preapprove, agree to, and/or otherwise consent to using an exceeding-available-funds service to complete a future exceeding-available-funds transaction involving the account, where the holder's consent is valid only if a predetermined condition is met. In some embodiments, the predetermined condition relates to the future exceeding-available-funds transaction, such that the holder's consent is valid only if the future exceeding-available-funds transaction is initiated and/or otherwise occurs during a predetermined period of time (e.g., during the day in which the holder gave his consent, during the week after the holder gave his consent, and the like). In other embodiments, the predetermined condition is such that the holder's consent is valid only if the transaction amount associated with the future exceeding-available-funds transaction is greater than a predetermined amount (e.g., $50, $250, and the like). In accordance with some embodiments, the holder or a financial institution can select the one or more terms of the predetermined condition.

Of course, in addition to attaching one or more predetermined conditions to the holder's consent, embodiments of the present invention also enable the holder to consent to one or more amount-exceeding-credit-threshold transactions before those amount-exceeding-credit-threshold transactions actually occur. It will be understood that account holders may have a financial incentive to consent to one or more future amount-exceeding-credit-threshold transactions before those amount-exceeding-credit-threshold transaction(s) actually occur. For example, in some embodiments, a regular amount-exceeding-credit-threshold cost associated with an amount-exceeding-credit-threshold transaction may be $35 if the holder consents at the time he engages in that amount-exceeding-credit-threshold transaction, but the amount-exceeding-credit-threshold cost may be only $10 if the holder consents in advance. Of course, there may be other incentives as well. For example, in some embodiments, by consenting to a future amount-exceeding-credit-threshold transaction before that transaction is initiated, the holder may not be required to provide his consent at the time of the transaction, which may spare the holder of any public embarrassment, annoyance, and/or hassle associated with providing his consent and/or being notified of the amount-exceeding-credit-threshold and/or amount-exceeding-credit-threshold cost during the transaction.

In more general terms, some embodiments of the present invention provide a method that includes: (a) receiving, from a holder of an account, consent to a future amount-exceeding-credit-threshold, where the future amount-exceeding-credit-threshold is a result of a future amount-exceeding-credit-threshold transaction involving the account, and where the consent is valid only if a predetermined condition is met; (b) receiving transaction information associated with a transaction, where the transaction involves the account, and where the transaction was initiated after the receiving the consent; (c) determining, using a processor and based at least partially on the transaction information, that the account will exceed a credit threshold associated with the account as a result of the transaction; (d) determining that the predetermined condition is met; and (e) authorizing the transaction based at least partially on the determining that the predetermined condition is met.

In some embodiments of the method, the predetermined condition relates to the future amount-exceeding-credit-threshold transaction, such that the consent is valid only if the future amount-exceeding-credit-threshold transaction is initiated during a predetermined period of time, and the transaction is initiated during the predetermined period of time. Additionally or alternatively, in some embodiments of the method, the predetermined condition relates to the future amount-exceeding-credit-threshold transaction, such that the consent is valid only for a predetermined number of future amount-exceeding-credit-threshold transactions involving the account, and where the transaction constitutes an amount-exceeding-credit-threshold transaction that is less than the predetermined number.

In some embodiments of the method, the predetermined condition relates to the future amount-exceeding-credit-threshold, such that the consent is valid only if the future amount exceeding a credit threshold is greater than a predetermined amount, and where the amount exceeding a credit threshold is greater than the predetermined amount. Additionally or alternatively, in some embodiments of the method, the predetermined condition relates to the future amount-exceeding-credit-threshold transaction, such that the consent is valid only if the transaction amount of the future amount-exceeding-credit-threshold transaction is greater than a predetermined amount, and where the transaction amount of the transaction is greater than the predetermined amount.

In some embodiments of the method, the predetermined condition relates to the future amount-exceeding-credit-threshold transaction, such that the consent is valid only if the future amount-exceeding-credit-threshold transaction involves a predetermined type of merchant, and where the transaction involves the predetermined type of merchant. Additionally or alternatively, in some embodiments of the method, the predetermined condition relates to the future amount-exceeding-credit-threshold transaction, such that the consent is valid only if the future amount-exceeding-credit-threshold transaction involves a predetermined type of channel, and where the transaction involves the predetermined type of channel.

In some embodiments of the method, the predetermined condition relates to the future amount-exceeding-credit-threshold transaction, such that the consent is valid only if the future amount-exceeding-credit-threshold transaction involves a merchant associated with a predetermined merchant category code, and where the transaction involves a merchant associated with the predetermined merchant category code. Additionally or alternatively, in some embodiments of the method, the predetermined condition relates to the type of the future amount-exceeding-credit-threshold transaction, such that the consent is valid only if the future amount-exceeding-credit-threshold transaction includes a predetermined transaction type, and where the transaction includes the predetermined transaction type.

In some embodiments, the method further includes: (a) prompting the holder to select the predetermined condition; and (b) receiving information indicating that the holder has selected the predetermined condition, where the receiving the information occurs before the receiving the transaction information. Additionally or alternatively, in some embodiments, the method further includes: (a) determining that the available balance or available credit for the account has fallen below a predetermined threshold; and (b) prompting the holder to consent to the future amount-exceeding-credit-threshold based at least partially on the determining that the available balance or available credit has fallen below the predetermined threshold, where the prompting the holder occurs before the receiving the consent.

In some embodiments, the method further includes: (a) assessing the account an amount-exceeding-credit-threshold cost based at least partially on determining that the account settled negative at the end of the day in which the transaction occurred; and/or (b) determining not to assess the account an amount-exceeding-credit-threshold cost based at least partially on determining that the account settled non-negative at the end of the day in which the transaction occurred. Additionally or alternatively, in some embodiments, the method further includes: (a) receiving, from a second holder of a second account, second consent to a second future amount-exceeding-credit-threshold, where the second future amount-exceeding-credit-threshold is a result of a second future amount-exceeding-credit-threshold transaction involving the second account, and where the second consent is valid only if a second predetermined condition is met; (b) receiving second transaction information associated with a second transaction, where the second transaction involves the second account, and where the second transaction was initiated after the receiving the second consent; (c) determining, based at least partially on the second transaction information, that the second account will exceed a credit threshold associated with the account as a result of the second transaction; (d) determining that the second predetermined condition is not met; and (e) declining the second transaction based at least partially on the determining that the second predetermined condition is not met.

In some embodiments, the method further includes storing information associated with the predetermined condition in an account profile associated with the account, where the account profile is stored in a datastore. In some of these embodiments, the determining that the predetermined condition is met is based at least partially on comparing the transaction information received to the information associated with the predetermined condition in the account profile.

As another example, other embodiments of the present invention provide an apparatus that includes: (a) a first communication interface configured to receive, from a holder of an account and via a telecommunications network, consent to a future amount-exceeding-credit-threshold, where the future amount-exceeding-credit-threshold is a result of a future amount-exceeding-credit-threshold transaction involving the account, and where the consent is valid only if a predetermined condition is met; (b) a second communication interface configured to receive, via a payment network, transaction information associated with a transaction, where the transaction involves the account, a transaction machine, and the holder of the account, and where the transaction was initiated after the first communication interface receives the consent; and (c) a processor operatively connected to the first communication interface and the second communication interface, and configured to: (i) determine, based at least partially on the transaction information, that the account will exceed a credit threshold associated with the account as a result of the transaction; (ii) determine that the predetermined condition is met; and (iii) authorize the transaction based at least partially on the processor determining that the predetermined condition is met.

In some of embodiments of the apparatus, the telecommunications network is a telephone network. Additionally or alternatively, in some embodiments, the apparatus further includes a memory device operatively connected to the processor and configured to store information associated with the predetermined condition (e.g., one or more terms of the predetermined condition, and the like) in an account profile associated with the account. In some of these embodiments, the processor determines that the predetermined condition is met is based at least partially on comparing the transaction information received to the information associated with the predetermined condition in the memory device.

As still another example, some embodiments of the present invention provide a computer program product having a non-transitory computer-readable medium. In some embodiments, the non-transitory computer-readable medium includes one or more computer-executable program code portions that, when executed by a computer, cause the computer to: (a) receive, from a holder of an account, consent to a future amount-exceeding-credit-threshold, where the future amount-exceeding-credit-threshold is a result of a future amount-exceeding-credit-threshold transaction involving the account, and where the consent is valid only if a predetermined condition is met; (b) receive transaction information associated with a transaction, where the transaction involves the account, and where the transaction was initiated after the computer receives the consent; (c) determine, based at least partially on the transaction information, that the account does not have adequate funds or credit to complete the transaction; (d) determine that the predetermined condition is met; and (e) provide funds or credit sufficient to complete the transaction based at least partially on the computer determining that the predetermined condition is met.

In some embodiments of the computer program product, the one or more computer-executable program code portions, when executed by the computer, cause the computer to provide the funds or credit sufficient to complete the transaction by providing only the minimum amount of funds or credit needed to complete the transaction. In other embodiments, the one or more computer-executable program code portions, when executed by the computer, cause the computer to provide the funds or credit sufficient to complete the transaction by crediting the account with the funds or the credit sufficient to complete the transaction. In still other embodiments of the computer program product, the transaction involves a counterparty, and the one or more computer-executable program code portions, when executed by the computer, cause the computer to provide the funds or credit sufficient to complete the transaction by providing the counterparty with the funds or credit sufficient to complete the transaction.

As yet another example, some embodiments of the present invention provide a method that includes: (a) receiving, from a holder of an account, preapproval to use an amount-exceeding-credit-threshold service to complete one or more future amount-exceeding-credit-threshold transactions, where the one or more future amount-exceeding-credit-threshold transactions involve the account and occur during a predetermined period of time; (b) receiving transaction information associated with a transaction, where the transaction involves the account, and where the transaction was initiated after the receiving the preapproval; (c) determining, using a processor and based at least partially on the transaction information, that the account does not have adequate funds or credit to complete the transaction; (d) determining that the holder's preapproval covers the transaction based at least partially on determining that the transaction has occurred during the predetermined period of time; and (e) using an amount-exceeding-credit-threshold service to complete the transaction based at least partially on the determining that the holder's preapproval covers the transaction.

In some embodiments of the method, the predetermined period of time includes the period of time after the holder gave his preapproval and before the end of the day in which the holder gave his preapproval. In other words, in such embodiments, the holder “consents for the day.” In some of these embodiments, the holder's preapproval covers only a limited number of the future amount-exceeding-credit-threshold transactions that occur later in the day. For example, in some embodiments, the holder's preapproval covers only a predetermined number of future amount-exceeding-credit-threshold transactions involving the account. As another example, in some embodiments, the holder's preapproval covers only those future amount-exceeding-credit-threshold transactions that involve an ATM.

### BRIEF DESCRIPTION OF THE DRAWINGS

Having thus described some embodiments of the present invention in general terms, reference will now be made to the accompanying drawings, wherein:

FIG. 1 is a flow diagram illustrating a general process flow for providing an amount-exceeding-credit-threshold service subject to a predetermined condition, in accordance with an embodiment of the present invention;

FIG. 2 is a flow diagram illustrating a more-detailed process flow for providing an amount-exceeding-credit-threshold service subject to a customer-selected, predetermined condition, in accordance with an embodiment of the present invention;

FIG. 3 is a block diagram illustrating technical components of a system for providing an amount-exceeding-credit-threshold service subject to one or more predetermined conditions, in accordance with an embodiment of the present invention;

FIG. 4 is a mixed block and flow diagram of a system for providing an exceeding-available-funds service subject to a predetermined time condition, in accordance with an embodiment of the present invention; and

FIG. 5 is a mixed block and flow diagram of a system for providing an amount-exceeding-credit-threshold service subject to a predetermined transaction amount condition, in accordance with an embodiment of the present invention.

### DETAILED DESCRIPTION OF EMBODIMENTS OF THE PRESENT INVENTION

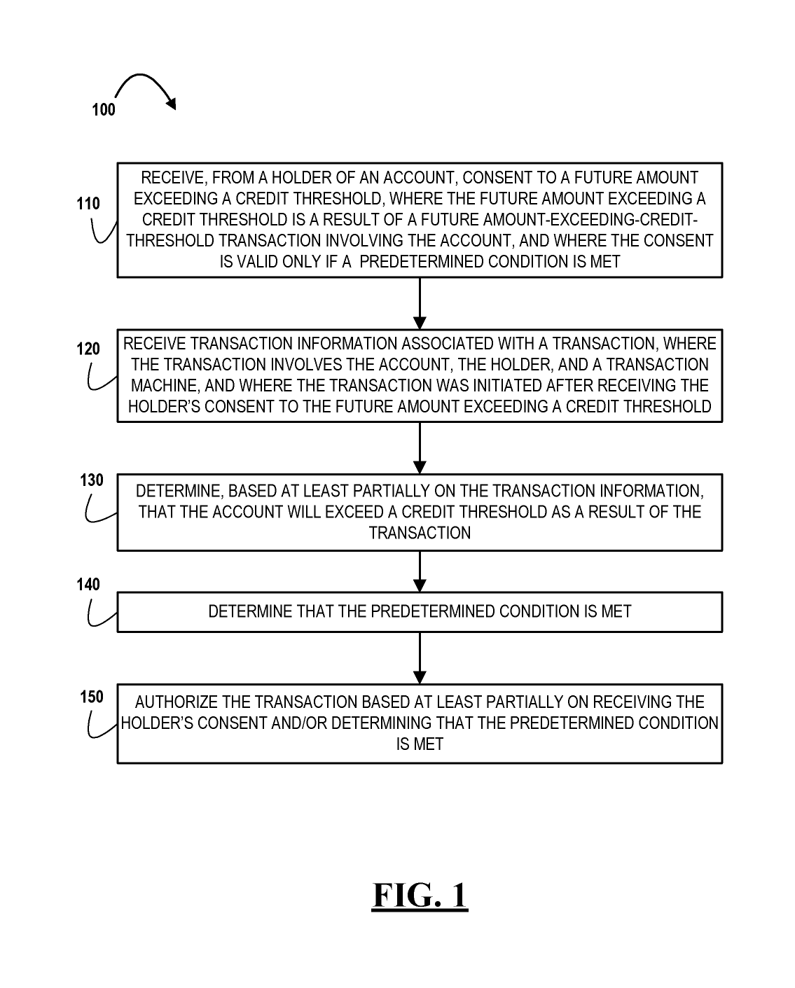

Referring now to FIG. 1, a general process flow 100 for providing an amount-exceeding-credit-threshold service subject to a predetermined condition is provided, in accordance with an embodiment of the present invention. In some embodiments, the process flow 100 is performed by an apparatus (i.e., one or more apparatuses) having hardware and/or software configured to perform one or more portions of the process flow 100. In such embodiments, as represented by block 110, the apparatus is configured to receive, from a holder of an account (e.g., deposit account, credit account, and the like), consent to a future amount-exceeding-credit-threshold, where the future amount-exceeding-credit-threshold is a result of a future amount-exceeding-credit-threshold transaction involving the account, and where the consent is valid only if a predetermined condition is met. As represented by block 120, the apparatus is further configured to receive transaction information associated with a transaction, where the transaction involves the account, the holder, and a transaction machine (e.g., a POS device, automated teller machine (ATM), personal computer, self-checkout machine, and the like), and where the transaction was initiated after the apparatus receives the holder's consent to the future amount-exceeding-credit-threshold. As represented by block 130, the apparatus is also configured to determine, based at least partially on the transaction information, that the account will exceed a credit threshold associated with the account (e.g., exceed available funds, and the like) as a result of the transaction. Also, as represented by block 140, the apparatus is configured to determine that the predetermined condition is met and/or that the holder's consent is valid for (e.g., covers) the transaction. Thereafter, as represented by block 150, the apparatus is configured to authorize the transaction based at least partially on receiving the holder's consent, determining that the predetermined condition is met, and/or determining that the holder's consent is valid for the transaction.

For simplicity, it will be understood that the portion of the process flow represented by block 130 is sometimes referred to herein as the “amount-exceeding-credit-threshold determination.” Also for simplicity, the portion of the process flow 100 represented by block 140 is sometimes referred to herein as the “condition determination.” Further, the phrase “amount-exceeding-credit-threshold transaction” is sometimes used herein to refer to a transaction that, if completed, would cause the account to exceed a credit threshold associated with the account (e.g., exceed available funds, go over a credit threshold, and the like).

In some embodiments, the term “determine” is meant to have one or more of its ordinary meanings (i.e., its ordinary dictionary definition(s)), but in other embodiments, the term “determine” is meant to have one or more of the ordinary meanings of one or more of the following terms: decide, conclude, verify, ascertain, find, discover, learn, calculate, observe, read, and/or the like. Also, in some embodiments, the term “via,” as used herein, is meant to have one or more of its ordinary meanings, but in other embodiments, the term “via” is meant to have one or more of the ordinary meanings of one or more of the following terms and/or phrases: from, through, per, with the assistance of, by way of, and/or the like. Further, in some embodiments, the phrase “based at least partially on” is meant to have one or more of its ordinary meanings, but in other embodiments, the phrase “based at least partially on” is meant to have one or more of the ordinary meanings of one or more of the following terms and/or phrases: in response to, because of, after, as a result of, and/or the like.

As used herein, the phrase “future amount-exceeding-credit-threshold transaction” generally refers to a transaction that: (a) is initiated, performed, engaged in, completed, and/or otherwise occurs in the future; and (b) if completed, will result in an amount exceeding a credit-threshold (i.e., a “future amount exceeding a credit threshold”). It will be understood that a future amount-exceeding-credit-threshold transaction refers to a potential transaction that has not yet occurred and may never occur; however, if the future amount-exceeding-credit-threshold transaction does occur, it will result in an amount exceeding a credit threshold. Also, as used herein, the phrase “amount-exceeding-credit-threshold cost” generally refers to the one or more costs (e.g., costs, assessments, and the like) typically associated with exceeding a credit threshold (e.g., exceeding available funds, and the like). Thus, the phrase “future amount-exceeding-credit-threshold cost” generally refers to one or more amount-exceeding-credit-threshold costs associated with incurring a “future amount exceeding a credit threshold,” which itself results from a “future amount-exceeding-credit-threshold transaction.”

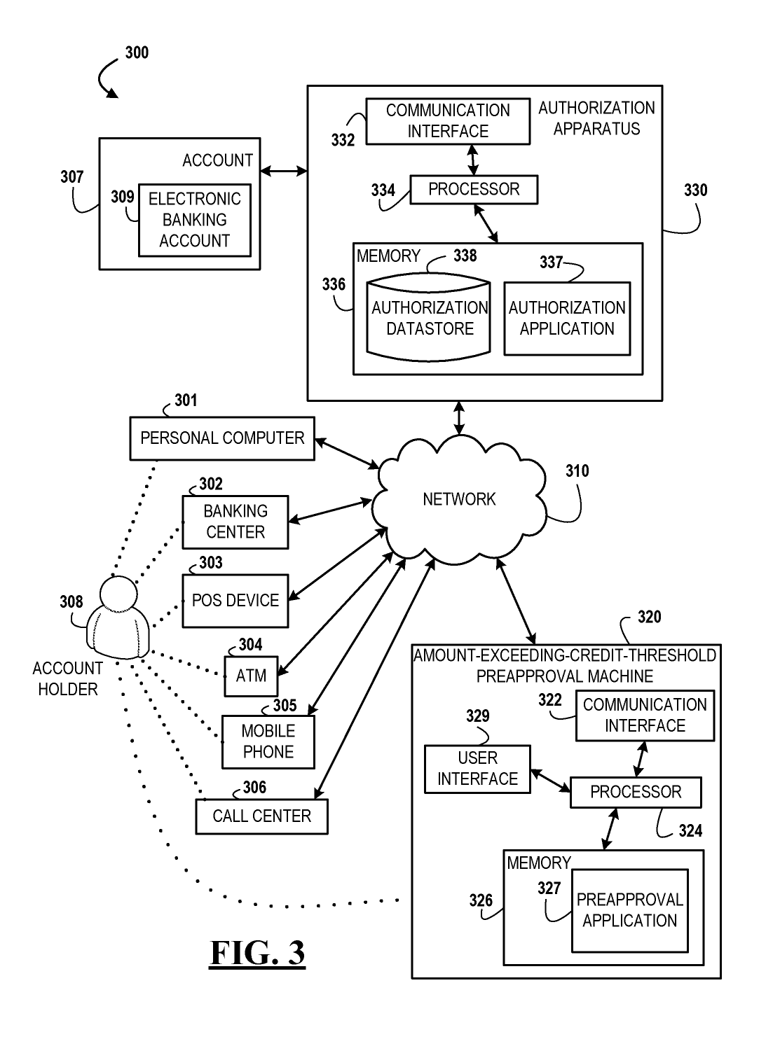

It will also be understood that the apparatus having the process flow 100 can include one or more separate and/or different apparatuses. For example, in some embodiments, one apparatus (e.g., the amount-exceeding-credit-threshold preapproval machine 320 described in connection with FIG. 3, and the like) is configured to perform the portion of the process flow 100 represented by block 110, and a second apparatus (e.g., the authorization apparatus 330, and the like) is configured to perform the portions represented by blocks 120-150. As still another example, in some embodiments, a single apparatus (e.g., the authorization apparatus 330) is configured to perform each and every portion of the process flow 100. It will also be understood that, in some embodiments, a transaction machine (e.g., the amount-exceeding-credit-threshold preapproval machine 320, personal computer 301, POS device 303, ATM 304, and the like) is configured to perform one or more (or all) of the portions of the process flow 100, and that in some embodiments, that transaction machine includes, is included in, and/or is embodied as the transaction machine referred to in block 110.

Regarding block 110, the future amount-exceeding-credit-threshold transaction and the future amount exceeding a credit threshold have not yet occurred at the time the holder's consent to the future amount exceeding a credit threshold is given and/or received. However, it will be understood that the transaction referred to in block 120 represents that future amount-exceeding-credit-threshold transaction, and the amount exceeding a credit threshold referred to in block 130 represents that future amount exceeding a credit threshold. In other words, the holder first provides consent to a future amount exceeding a credit threshold, as represented by block 110, and then later exceeds the credit threshold associated with the account by engaging in the transaction referred to in block 120. In this way, the holder can preapprove and/or consent in advance to one or more amounts exceeding a credit threshold and/or amount-exceeding-credit-threshold transactions that have not yet occurred, so that that the holder does not have to approve and/or consent to those one or more amounts exceeding a credit threshold and/or amount-exceeding-credit-threshold transactions when they actually do occur. Advantageously, this may spare the holder of any public embarrassment, annoyance, and/or hassle associated with providing his consent and/or being notified of the amount exceeding a credit threshold and/or amount-exceeding-credit-threshold cost during the transaction.

As used herein, the phrase “consent to the future amount exceeding a credit threshold” is meant to be understood in its broadest sense. For example, in some embodiments, the phrase “consent to the future amount exceeding a credit threshold” means consent to: (a) exceeding a credit threshold (e.g., the account and/or the holder incurring the future amount exceeding a credit threshold, and the like); (b) incurring an amount-exceeding-credit-threshold cost associated with the future amount exceeding a credit threshold (e.g., at the time the credit threshold is exceeded and/or at the end of the day in which the credit threshold is exceeded if the account settles negative at the end of the day, and the like); (c) one or more terms of an amount-exceeding-credit-threshold service (discussed in more detail below); (d) using an amount-exceeding-credit-threshold service to cover the future amount exceeding a credit threshold and/or to complete the future amount-exceeding-credit-threshold transaction; (e) incurring an amount-exceeding-credit-threshold cost associated with using the amount-exceeding-credit-threshold service to cover the future amount exceeding a credit threshold and/or to complete the future amount-exceeding-credit-threshold transaction; and/or the like.

Regarding blocks 110 and 140, in some embodiments, the holder's consent is subject to one or more predetermined conditions. In accordance with some embodiments, a predetermined condition includes one or more terms that define the predetermined condition and/or how the predetermined condition can be met. For example, in some embodiments, the predetermined condition relates to the future amount-exceeding-credit-threshold transaction, such that the consent is valid only if the future amount-exceeding-credit-threshold transaction is initiated during a predetermined period of time (e.g., during a predetermined minute, hour, day, week, month, year, and the like). In other words, the one or more terms of the predetermined condition define that the predetermined condition is met if the future amount-exceeding-credit-threshold transaction is initiated during the predetermined period of time. Thus, in such embodiments, if the apparatus determines that the transaction referred to in block 120 is initiated during the predetermined period of time, then the apparatus will determine that the predetermined condition is met. As a specific example, in some embodiments, the holder's consent is valid only if the future amount-exceeding-credit-threshold transaction is initiated (and/or otherwise occurs) during the month of March. As another example, in some embodiments, the holder's consent is valid only if the future amount-exceeding-credit-threshold transaction is initiated (and/or otherwise occurs) sometime in the week after the holder gave his consent. As still another example, in some embodiments, the holder's consent is valid only if the future amount-exceeding-credit-threshold transaction is initiated during the same day that the holder gave his consent (e.g., when the holder “consents for the day,” and the like).

In other embodiments, the predetermined condition is such that the consent is valid only for a predetermined number of future amount-exceeding-credit-threshold transactions involving the account (e.g., within a predetermined period of time or over an indefinite period of time). In other words, the one or more terms of the predetermined condition place a maximum on the number of amount-exceeding-credit-threshold transactions in which the account can engage. For example, in some embodiments, the holder's consent may be valid for only five amount-exceeding-credit-threshold transactions (but no more than five). In such embodiments, if the apparatus determines that the transaction referred to in block 120 constitutes the sixth amount-exceeding-credit-threshold transaction incurred by the account since the holder's consent was received, then the apparatus will not authorize the transaction. However, in such embodiments, if the apparatus determines that the transaction referred to in block 120 constitutes, for example, the second amount-exceeding-credit-threshold transaction since the holder's consent was received, then the apparatus will authorize the transaction. In other words, in some embodiments, if the predetermined condition is such that the consent is valid only for a predetermined number of future amount-exceeding-credit-threshold transactions, the predetermined condition will be met if the transaction referred to in block 120 is less than and/or within that predetermined number.

In some embodiments, the predetermined condition relates to the future amount exceeding a credit threshold, such that the consent is valid only if the future amount exceeding a credit threshold is less than, greater than, or equal to a predetermined amount. For example, in some embodiments, the holder's consent may be valid only if the amount exceeding a credit threshold is greater than $50 because, for example, the holder does not want to pay an amount-exceeding-credit-threshold cost for incurring a relatively small amount exceeding a credit threshold (e.g., the holder does not want to pay a $35 exceeding-available-funds cost for exceeding funds available in his account by $5, and the like). In such embodiments, if the apparatus determines that the amount exceeding a credit threshold referred to in block 130 is less than the predetermined amount of $50, then the apparatus will determine that the predetermined condition is not met and/or will decline the transaction.

In some embodiments, the predetermined condition relates to the transaction amount of the future amount-exceeding-credit-threshold transaction, such that the consent is valid only if the transaction amount of the future amount-exceeding-credit-threshold transaction is greater than, less than, or equal to a predetermined amount (e.g., selected by the holder, provided for the holder, and the like). For example, in some embodiments, the holder may preapprove only those future amount-exceeding-credit-threshold transactions having transaction amounts greater than $50. In such embodiments, the holder may not want to engage in an amount-exceeding-credit-threshold transaction (and incur an amount-exceeding-credit-threshold cost) if that amount-exceeding-credit-threshold transaction involves a relatively small and/or discretionary purchase (e.g., the holder does not want to incur a $35 exceeding-available-funds cost for purchasing a $10 item, and the like). However, the customer may want to engage in an amount-exceeding-credit-threshold transaction if that amount-exceeding-credit-threshold transaction involves a relatively large and/or an emergency and/or non-discretionary purchase (e.g., the holder may want to incur a $35 exceeding-available-funds cost in order to make his $900 monthly mortgage payment, and the like).

In still other embodiments, the predetermined condition is such that the holder's consent is valid only if the future amount-exceeding-credit-threshold transaction involves a predetermined merchant and/or type of merchant, a predetermined channel and/or type of channel, a predetermined transaction and/or type of transaction, and/or the like. For example, in some embodiments, the predetermined condition is such that the holder's consent is valid only if the future amount-exceeding-credit-threshold transaction involves a predetermined telephone company and/or any telephone company. As another example, in some embodiments, the predetermined condition is such that the holder's consent is valid only if the future amount-exceeding-credit-threshold transaction involves one or more predetermined merchant category codes (e.g., “5411” for grocery supermarkets, “5814” for fast food restaurants, “5541” for service stations, and the like). As still another example, in some embodiments, the predetermined condition is such that the holder's consent is valid only if the future amount-exceeding-credit-threshold transaction is performed at and/or otherwise involves a predetermined ATM (e.g., the ATM at the intersection of 5th and College in Charlotte, N.C., and the like) and/or any ATM. As yet another example, in some embodiments, the predetermined condition is such that the holder's consent is valid only if the future amount-exceeding-credit-threshold transaction involves the holder's monthly mortgage payment, regular student loan payment, and/or any other type of loan payment.

It will be understood that the condition referred to in block 110 is a “predetermined condition” because that condition is inputted, chosen, set, and/or otherwise selected before or at the time the holder indicates his consent to the future amount exceeding a credit threshold. Additionally or alternatively, in other embodiments, the condition is a “predetermined condition” because that condition is selected before the future amount-exceeding-credit-threshold transaction relating to the predetermined condition is actually initiated and/or otherwise actually occurs. For example, in accordance with such embodiments, the condition referred to in block 110 is a “predetermined condition” because it is selected before the amount-exceeding-credit-threshold transaction referred to in block 120 is initiated and/or otherwise occurs.

In some embodiments, the customer selects and/or provides the predetermined condition and/or the one or more terms thereof. However, in other embodiments, the predetermined condition and/or its one or more terms are selected for, and/or provided to, the customer by, for example, a financial institution. Also, it will be understood that the holder's preapproval and/or consent can be subject to more than one predetermined condition. For example, in some embodiments, the holder's preapproval covers one or more future amount-exceeding-credit-threshold transactions only if each of those one or more future amount-exceeding-credit-threshold transactions: (a) occurs after the holder gave his preapproval but on the same day that the holder gave his preapproval (e.g., occurs on Tuesday afternoon if the holder gave his preapproval on Tuesday morning); (b) has a transaction amount that is greater than a predetermined amount (e.g., $25); and (c) involves an predetermined channel (e.g., ATM).

In addition, in accordance with some embodiments, if the apparatus having the process flow 100 determines that the predetermined condition is met, the apparatus may: (a) authorize the transaction, as represented by block 150; (b) send the holder a message that includes information about the amount exceeding a credit threshold, information about an amount-exceeding-credit-threshold cost associated with the amount exceeding a credit threshold, the reason for authorizing the transaction (e.g., why/how the predetermined condition was met, and the like), and/or the like; (c) use an amount-exceeding-credit-threshold service to cover the amount exceeding a credit threshold and/or complete the transaction (e.g., provide funds and/or credit to the account to complete the transaction, and the like); (d) assess the account and/or the holder an amount-exceeding-credit-threshold cost for using the amount-exceeding-credit-threshold service to cover the amount exceeding a credit threshold and/or to complete the transaction; (e) charge the account and/or the holder an amount-exceeding-credit-threshold cost for exceeding a credit threshold associated with the account; and/or the like. However, in some embodiments, if the apparatus determines that the predetermined condition is not met, the apparatus may: (a) decline the transaction; and/or (b) send the holder a message that includes information about the amount exceeding a credit threshold, the reason for declining the transaction (e.g., why/how the predetermined condition was not met, and the like), and/or the like.

Further regarding block 110, the holder can provide his preapproval and/or consent to the future amount exceeding a credit threshold in any way and/or using any apparatus. For example, in some embodiments, the holder provides his consent via an amount-exceeding-credit-threshold preapproval machine (e.g., the amount-exceeding-credit-threshold preapproval machine 320 described in connection with FIG. 3, and the like), a mobile device (e.g., mobile phone, portable gaming device, PDA, tablet computer, and the like), a transaction machine (e.g., ATM, POS device, and the like), a call center, an electronic banking account (e.g., online banking account, mobile banking account, text banking account, and the like), regular mail, email, text message, and/or the like.

Regarding block 120, the phrase “transaction machine,” as used herein, typically refers to an interactive computer terminal that is configured to initiate, perform, complete, and/or otherwise facilitate one or more transactions. Examples of transaction machines include, but are not limited to, POS devices (e.g., merchant terminals, and the like), automated teller machines (ATMs), self-service machines (e.g., vending machine, self-checkout machine, parking meter, and the like), public and/or business kiosks (e.g., an Internet kiosk, ticketing kiosk, bill pay kiosk, and the like), mobile phones (e.g., feature phone, smart phone, and the like), gaming devices, computers (e.g., personal computers, tablet computers, laptop computers, and the like), personal digital assistants (PDAs), and/or the like. In some embodiments, the transaction machine is an amount-exceeding-credit-threshold preapproval machine (e.g., the amount-exceeding-credit-threshold preapproval machine 320, and the like), and/or vice versa. For example, in some embodiments, the holder uses an amount-exceeding-credit-threshold preapproval machine (e.g., mobile device, ATM, POS device, and the like) to consent to the future amount exceeding a credit threshold referred to in block 110, and that same amount-exceeding-credit-threshold preapproval machine is also the transaction machine referred to in block 120.

In some embodiments, the transaction machine referred to in block 120 is configured to send and/or receive communications (e.g., text messages, actionable alerts, phone calls, emails, social media-specific messages, and the like), present information via a user interface, navigate the Internet, play video games, and/or the like. For example, in some embodiments, the transaction machine is a smart phone capable of initiating, performing, completing, and/or otherwise facilitating financial transactions. In some embodiments, the transaction machine is portable (e.g., not stationary) and/or can be carried and/or worn by and/or on a person. In some embodiments, the transaction machine includes one or more near field communication (NFC) interfaces that are configured to communicate with one or more NFC interfaces associated with a mobile device (e.g., mobile phone, PDA, portable gaming device, and the like). For example, in some embodiments, the NFC interface of a mobile phone can communicate account information and/or transaction information (e.g., account names, routing numbers, account numbers, usernames, passwords, PINs, transaction amounts, and the like) to and/or from the NFC interface of the transaction machine. In some of these embodiments, the mobile phone is configured to operate as a mobile wallet, meaning that the mobile phone can be used to make payments and/or otherwise engage in transactions at the transaction machine.

In some embodiments, the transaction machine referred to in block 120 is located in a public place and is available for public use (e.g., on a street corner, on the exterior wall of a banking center, at a public rest stop, and the like). In other embodiments, the transaction machine is additionally or alternatively located in a place of business and available for public and/or business customer use (e.g., in a retail store, post office, banking center, grocery store, and the like). In accordance with some embodiments, the transaction machine is not owned by the user of the transaction machine and/or the holder of the account referred to in block 110. However, in other embodiments, the transaction machine is located in a private place, is available for private use, and/or is owned by the user of the transaction machine and/or the holder referred to in block 120.

Further regarding block 120, the transaction involving the holder and the transaction machine can include any number and/or type of transaction(s) involving a transaction machine. For example, in some embodiments, the transaction includes one or more of the following: purchasing, renting, selling, and/or leasing goods and/or services (e.g., groceries, stamps, tickets, DVDs, vending machine items, and the like); withdrawing cash; making payments to creditors (e.g., paying monthly bills; paying federal, state, and/or local taxes and/or bills; and the like); sending remittances; transferring balances from one account to another account; loading money onto stored value cards; donating to charities; and/or the like. Like the transaction referred to in block 120, the future amount-exceeding-credit-threshold transaction referred to in block 110 can also include any number and/or type of transaction(s) involving a transaction machine (i.e., since the future amount-exceeding-credit-threshold transaction referred to in block 110 is the transaction referred to in block 120).

Also, the account referred to in the process flow 100 can include any number and/or type of account(s). For example, in some embodiments, the account includes a checking account, savings account, money market account, investment account, brokerage account, certificate of deposit account, and/or any other type of deposit account. In some embodiments, the deposit account is one or more accounts that can exceed available funds. Of course, it will be understood that embodiments of the present invention may also apply to one or more credit accounts, such as a credit card account, line of credit (LOC) account, store credit account, and/or the like. Additionally or alternatively, in some embodiments, the credit account is one or more accounts that can exceed a credit threshold.

In some embodiments, the account, the transaction machine, and the apparatus having the process flow 100 are each controlled, serviced, owned, managed, operated, and/or maintained (collectively referred to herein as “maintained” for simplicity) by a single financial institution. For example, in some embodiments, the apparatus is maintained by a bank, the account is maintained by the bank, the transaction machine is owned by the bank, and the holder is a customer of the bank. Of course, it will be understood that, in some embodiments, the apparatus, the transaction machine, and/or the account are not maintained by the same financial institution (or any financial institution).

The transaction information referred to in block 120 can be any information that identifies, defines, describes, and/or is otherwise associated with the transaction. Exemplary transaction information includes, but is not limited to, the party(ies) involved in the transaction, the date and/or time of the transaction (e.g., when the transaction was initiated, and the like), the account(s) involved in the transaction, the transaction amount(s) associated with the transaction, the good(s) and/or service(s) involved in the transaction (e.g., product names, stock keeping unit (SKU) information, universal product code (UPC) information, and the like), a description of the transaction (which, itself, can include any transaction information, e.g., the description may describe the transaction status, the goods and/or services involved in the transaction, and the like), and/or the like.

The transaction information can also include any information that defines and/or identifies the type of the transaction. As understood herein, the transaction type of a transaction may be defined, at least in part, by the one or more goods and/or services involved in the transaction, the one or more types of accounts involved in the transaction (e.g., credit card transaction, savings account transaction, and the like), the one or more parties involved in the transaction (e.g., account holder, bank, teller, merchant, counterparty, and the like), when the transaction was initiated (e.g., time of day, day of week, and the like), and/or the like. In some embodiments, the transaction type is defined, at least in part, by the one or more channels through which the transaction is conducted, such as, for example, a POS device (e.g., merchant terminal, and the like), ATM, teller terminal, electronic banking account (e.g., online banking account, mobile banking account, SMS banking account, and the like), personal computer, kiosk, call center, and/or the like. Additionally or alternatively, in some embodiments, the transaction type is defined, at least in part, by the one or more instruments and/or methods used to conduct the transaction, such as, for example, paper checks, electronic checks, debit cards, credit cards, ATM cards, checkcards, wire transfers, online bill pay, automated clearing house (ACH), contactless payments, near field communication (NFC) interface payments, cash payments, and/or the like.

In some embodiments, the transaction information additionally or alternatively identifies and/or describes one or more merchant category codes (MCCs) associated with the transaction. As used herein, the phrase “merchant category code” generally refers to a number assigned to a merchant by a financial institution, where the number is used to classify the merchant by the type of goods and/or services the merchant provides. In some embodiments, the merchant category code is a four digit number assigned by a credit card provider (which, in some embodiments, is a bank). Exemplary merchant category codes include “5814” for fast food restaurants, “5933” for pawn shops, “8062” for hospitals, “5411” for grocery supermarkets, and “3501” for a hotel. A merchant category code may generally refer to the goods and/or services provided by a merchant (e.g., hospital, fast food restaurant, and the like) and/or may specifically identify the name of an individual merchant. In other words, individual industries and/or individual merchants can have their own merchant category codes. In some embodiments, a transaction type may be defined, at least in part, by one or more merchant category codes associated with the transaction.

It will be understood that any given transaction may have more than one transaction type. For example, in accordance with some embodiments, a cash withdrawal transaction conducted an ATM may be defined as a cash-related transaction, a withdrawal transaction, and/or an ATM transaction. As another example, in accordance with some embodiments, a purchase transaction involving a POS device and a mobile device, where each of the POS device and the mobile device has an NFC interface, may be defined as a purchase transaction, a POS device transaction, mobile device transaction, an NFC interface transaction, and/or a contactless payment transaction. As still another example, in accordance with some embodiments, a purchase transaction involving a POS device maintained by a grocery store may be defined as a purchase transaction, a POS device transaction, a grocery store transaction, and/or a merchant category code “5411” transaction.

Also regarding block 120, the apparatus having the process flow 100 can be configured to receive the transaction information in any way. For example, in some embodiments, the apparatus is configured to receive an authorization request associated with the transaction, where the authorization request includes the transaction information. In some embodiments, the apparatus is embodied as an authorization apparatus maintained by a financial institution, where the apparatus is configured to consider, approve, and/or decline authorization requests for debit transactions, credit transactions, ATM transactions, POS device transactions, and/or one or more other types of transactions that involve one or more accounts maintained by the financial institution.

In some embodiments, the apparatus having the process flow 100 is configured to receive the transaction information based at least partially on the holder presenting account information (e.g., account number, debit card number, credit card number, credentials, PIN, expiration date of debit card or credit card, card verification value (CVV), name(s) of holder(s) of the account, and the like) at the transaction machine. For example, in some embodiments, the holder presents account information at the transaction machine by swiping a debit card or credit card through the POS device. As another example, in some embodiments, the holder presents account information at the transaction machine by inputting account information into the transaction machine via a user interface associated with the transaction machine. As still another example, in some embodiments, the holder presents account information at the transaction machine by “tapping” an NFC-enabled mobile device at an NFC-enabled transaction machine (e.g., holding the NFC interface of the mobile device within approximately four inches of the NFC interface of the transaction machine, and the like) in order to communicate the account information from the mobile device to the transaction machine.

Additionally or alternatively, the apparatus having the process flow 100 can be configured to receive the transaction information directly or indirectly from the source of the transaction. For example, in some embodiments, the apparatus is located remotely from the transaction machine but is operatively connected to the transaction machine via a payment network, telephone network, and/or some other telecommunications network. As another example, the apparatus may include, be included in, and/or be embodied as a transaction machine. For example, in some embodiments, the apparatus having the process flow 100 includes the transaction machine referred to in block 110. As still another example, in some embodiments, the apparatus having the process flow 100 is embodied as a transaction machine separate from, and/or different than, the transaction machine mentioned in the process flow 100.

Regarding block 130, the term “amount exceeding a credit threshold,” as used herein, generally refers to the difference between: (a) the total amount of one or more purchases, draws, costs, assessments, balance transfers, debt obligations, and/or other liabilities incurred, or that will be incurred, by an account as a result of a transaction, and (b) the amount of funds and/or credit available to the account immediately prior to the transaction. In some embodiments, the amount exceeding a credit threshold is referred to as an amount exceeding available funds if the account that exceeds the credit threshold, or will exceed with credit threshold, is a deposit account. For example, if a checking account has an available balance of $25 immediately before the checking account is used to pay a $50 electric bill, then the checking account will exceed available funds by $25 as a result of paying the bill. In some embodiments, the amount exceeding available funds refers to the amount by which the balance of an account is negative. For example, if a deposit account has an available balance of −$65, then the deposit account has one or more amounts exceeding available funds totaling $65. Additionally or alternatively, in some embodiments, the exceeding a credit threshold refers to a situation where a deposit account is found to have inadequate funds to cover a transaction.

In some embodiments, the account that exceeds or will exceed a credit threshold is a credit account. For example, if a credit account has $500 in available credit immediately prior to the credit account being used to make a $600 purchase, then it will be understood that the credit account will go over its credit threshold by $100 as a result of the purchase. Additionally or alternatively, in some embodiments, the phrase “amount exceeding a credit threshold” generally refers to the difference between an account balance for the credit account and a credit threshold (sometimes referred to as “credit line”) associated with the credit account. For example, if a credit account has a $5,000 credit threshold and a $5,300 account balance, then it will be understood that the credit account exceeding a credit threshold by $300.

Further regarding block 130, the apparatus configured to perform the process flow 100 can be configured to determine that the account will exceed a credit threshold associated with the account as a result of a present, initiated, and/or pending transaction. For example, in some embodiments, the apparatus is configured to make the amount-exceeding-credit-threshold determination based at least partially on determining that the transaction has been initiated (e.g., at a POS device), but has not yet been completed. In addition, the apparatus can be configured to make the amount-exceeding-credit-threshold determination in any way. For example, in some embodiments, the apparatus is configured to make the amount-exceeding-credit-threshold determination by determining that the account does not have sufficient available funds and/or credit to cover the transaction. In some embodiments, the apparatus having the process flow 100 includes and/or is embodied as a financial transaction processing apparatus that is configured to process financial transactions involving the account and/or the transaction machine referred to in block 120. In some of these embodiments, the apparatus is configured to make amount-exceeding-credit-threshold determinations and/or condition determinations for the account at the same time as, and/or nearly the same time as, the apparatus is processing transactions involving the account.

In some embodiments, the apparatus includes and/or is embodied as an authorization apparatus (e.g., the authorization apparatus 330 referred to in FIG. 3, and the like) that is configured to consider, authorize, and/or decline authorization requests and/or financial transactions. The apparatus configured to perform the process flow 100 can be configured to make amount-exceeding-credit-threshold determinations and/or condition determinations in real time and/or in substantially real time. In some embodiments, the apparatus is configured to determine the amount exceeding a credit threshold immediately or nearly immediately after the amount-exceeding-credit-threshold transaction has been initiated at the transaction machine (e.g., upon the swipe of a debit or credit card through a POS device, upon the holder selecting an amount to withdraw from an ATM, and the like). However, the apparatus having the process flow 100 can be configured to make the amount-exceeding-credit-threshold determination and/or the condition determination at any time from when the holder approaches the transaction machine to when the holder leaves the transaction machine. Additionally or alternatively, the apparatus can be configured to make the amount-exceeding-credit-threshold determination and/or condition determination at any time from when the holder initiates and/or engages in the transaction at the transaction machine to when the transaction is completed.

Regarding block 140, the apparatus can be configured to make the condition determination in any way. For example, in some embodiments, the apparatus is configured to store the one or more terms of the predetermined condition and/or other information associated with the predetermined condition (collectively, the “condition information”) in a datastore, and the apparatus is configured to make the condition determination based at least partially on accessing the datastore and/or comparing the condition information to the transaction information referred to in block 120. Of course, depending on the one or more terms of the predetermined condition, the apparatus may compare the condition information to something other than the transaction information referred to in block 120. For example, if the predetermined condition relates to the number of exceeding-available-funds transactions involving the account, the apparatus may be configured to compare the condition information to, for example, the transaction history associated with the account (e.g., to determine the number of exceeding-available-funds transactions in which the account has engaged over a particular period of time, and the like). As another example, if the predetermined condition relates to the amount by which the account has exceeded a credit threshold, the apparatus may be configured to compare the condition information to, for example, the available balance and/or credit associated with the account (e.g., as a result of the amount-exceeding-credit-threshold transaction, immediately before the amount-exceeding-credit-threshold transaction, and the like). As still another example, if the predetermined condition relates to a merchant and/or channel involved in the transaction, the apparatus may be configured to compare the condition information to, for example, one or more rules for determining merchant types and/or channel types, where those one or more rules are stored in one or more databases and/or other bank systems.

Regarding block 150, the apparatus can be configured to authorize the transaction in any way. For example, in some embodiments, the apparatus is configured to send, to the transaction machine referred to in the process flow 100, one or more instructions to complete (and/or for completing) the transaction. In some embodiments, the apparatus is configured to authorize the transaction by approving an authorization request associated with the transaction. In some embodiments, the authorization request approved by the apparatus having the process flow 100 was included in the transaction information referred to in block 120. In some embodiments where the transaction machine referred to in blocks 120 is the apparatus having the process flow 100, the transaction machine authorizes and/or completes the transaction based at least partially on making the amount-exceeding-credit-threshold determination, making the condition determination, and/or determining that the consent is valid (e.g., covers) the transaction. In some embodiments, the transaction machine completes the transaction by performing one or more meaningful actions relevant to the transaction, such as, for example, dispensing cash, accepting a purchase transaction, accepting a check deposit, printing a receipt and/or statement, loading a prepaid card, transferring funds, and/or the like. In some embodiments, these one or more actions constitute the exchange central to the transaction, define the transaction, are desired by the holder to be performed, and/or were the reason the holder arrived at the transaction machine in the first place.

In accordance with some embodiments, the apparatus configured to perform the process flow 100 is configured to perform the portions of the process flow 100 represented by blocks 120-150 at some point after the holder approaches the transaction machine for the transaction and before the holder leaves the transaction machine. In some embodiments, this means that the apparatus is configured to perform the one or more portions of the process flow 100 (e.g., receive the transaction information, make the amount-exceeding-credit-threshold determination, make the condition determination, authorize the transaction, and the like) during the transaction involving the transaction machine and the holder and/or while the holder is still at the transaction machine.

The apparatus configured to perform the process flow 100 can be configured to perform any of the portions of the process flow 100 represented by blocks 110-150 upon or after one or more triggering events (which, in some embodiments, is one or more of the other portions of the process flow 100). As used herein, a “triggering event” refers to an event that automatically (i.e., without human intervention) triggers the execution, performance, and/or implementation of a triggered action, either immediately, nearly immediately, or sometime after (e.g., within minutes, and the like) the occurrence of the triggering event. For example, in some embodiments, the apparatus configured to perform the process flow 100 is configured such that the apparatus making the amount-exceeding-credit-threshold determination (the triggering event) automatically and immediately or nearly immediately (e.g., within 1-30 seconds, and the like) triggers the apparatus to determine whether (and/or that) the predetermined condition is met and/or whether (and/or that) the consent is valid for the transaction (the triggered action(s)). In some embodiments, the apparatus is additionally or alternatively configured to authorize and/or complete the transaction (triggered action) automatically and immediately or nearly immediately after determining that the predetermined condition is met and/or that the consent is valid (triggering event).

In accordance with some embodiments, the apparatus configured to perform the process flow 100 is configured to automatically perform one or more of the portions of the process flow 100 represented by blocks 110-150, whereas in other embodiments, one or more of the portions of the process flow 100 represented by blocks 110-150 require and/or involve human intervention (e.g., a user operating the apparatus configured to perform the process flow 100, and the like). In addition, it will be understood that, in some embodiments, the apparatus configured to perform the process flow 100 (and/or a user thereof) is configured to perform one or more portions (or combinations of portions) of the process flow 100, from start to finish, within moments, seconds, and/or minutes (e.g., within approximately 1-15 minutes from start to finish, and the like). As an example, in some embodiments, the apparatus having the process flow 100 is configured to authorize and/or complete the transaction within moments, seconds, and/or minutes (e.g., within approximately 1-15 minutes, and the like) of: (a) receiving the transaction information associated with the transaction; and/or (b) determining that the account will exceed a credit threshold associated with the account as a result of the transaction.

As mentioned above, in some embodiments, the apparatus having the process flow 100 is configured to provide, implement, and/or is otherwise associated with an amount-exceeding-credit-threshold service. For example, in some embodiments, the apparatus is configured to prompt, via a user interface associated with an amount-exceeding-credit-threshold preapproval machine, the holder to consent to, accept, preapprove, and/or agree to (collectively referred to herein as “agree to” for simplicity) one or more terms of the amount-exceeding-credit-threshold service. In some embodiments, the apparatus prompts the holder to agree to the one or more terms of the amount-exceeding-credit-threshold service by prompting the holder to “opt into” and/or otherwise enroll in the amount-exceeding-credit-threshold service. In some embodiments, as required by one or more laws, rules, and/or regulations, the holder must opt into the amount-exceeding-credit-threshold service before the holder can participate in and/or otherwise use the amount-exceeding-credit-threshold service. It will be understood that the holder may enroll in the amount-exceeding-credit-threshold service at a banking center, through an electronic banking account, via a call center, and/or in some other way.

Additionally or alternatively, in some embodiments, the apparatus is configured to receive the holder's consent to the future amount exceeding a credit threshold (and/or to an associated amount-exceeding-credit-threshold cost), as represented by block 110, by receiving the holder's agreement to the one or more terms of the amount-exceeding-credit-threshold service. Still further, in some embodiments, the apparatus is configured to send a confirmation message to the holder, where the confirmation message includes information that confirms the holder's agreement to the one or more terms of the amount-exceeding-credit-threshold service (and/or the holder's agreement to opt into and/or otherwise enroll in the amount-exceeding-credit-threshold service, and/or the holder's agreement to use the amount-exceeding-credit-threshold service for the future amount-exceeding-credit-threshold transaction). In other embodiments, the apparatus is configured to send this confirmation message to the holder's mobile device, to an electronic banking account (e.g., online banking account, mobile banking account, and the like) associated with the account, and/or to the amount-exceeding-credit-threshold preapproval machine that the holder used to indicate his consent to the future amount exceeding a credit threshold.

As used herein, the phrase “amount-exceeding-credit-threshold service” generally refers to a service that provides an account holder, account, and/or counterparty with the funds and/or credit necessary to complete an amount-exceeding-credit-threshold transaction. For example, in some embodiments, where a transaction, if completed, would exceed the funds available in a checking account by $10, the amount-exceeding-credit-threshold service can provide the checking account with the $10 needed to complete the transaction.

It will be understood that the amount-exceeding-credit-threshold service includes one or more terms, which define the one or more rights, responsibilities, privileges, costs, features, and/or obligations of the amount-exceeding-credit-threshold service. For example, in some embodiments, the one or more terms of the amount-exceeding-credit-threshold service describe how the amount-exceeding-credit-threshold service works; identify the amount-exceeding-credit-threshold service provider; define what constitutes an amount exceeding a credit threshold; identify the one or more amount-exceeding-credit-threshold costs assessed for enrolling in the amount-exceeding-credit-threshold service, for participating in the amount-exceeding-credit-threshold service, and/or for engaging in an amount-exceeding-credit-threshold transaction; and/or the like.

In some embodiments, the amount-exceeding-credit-threshold service is provided by a financial institution, such as a bank, and is funded by that financial institution (and not by an account held by and/or otherwise associated with the holder). For example, in some embodiments, the amount-exceeding-credit-threshold service is provided by the same financial institution that maintains the transaction machine, the apparatus configured to perform the process flow 100, and/or the account that exceeds or will exceed a credit threshold associated with the account. It will be understood that, in some embodiments, the amount-exceeding-credit-threshold service (and/or the amount-exceeding-credit-threshold service provider) is regulated in the United States by the Electronic Funds Transfer Act, also known as Federal Reserve Board Regulation E (hereinafter “Regulation E”). In other embodiments, the amount-exceeding-credit-threshold service (and/or amount-exceeding-credit-threshold service provider) is regulated in the United States by the Credit Card Accountability Responsibility and Disclosure Act of 2009, which is codified in the United States as Public Law No. 111-24 (sometimes referred to herein, for simplicity, as the “Credit CARD Act of 2009” or the “CARD Act”). In some embodiments, the amount-exceeding-credit-threshold service does not contractually obligate the amount-exceeding-credit-threshold service provider to cover amounts exceeding a credit threshold. In other words, in such embodiments, the amount-exceeding-credit-threshold service provider may choose to cover transactions that exceed a credit threshold at its discretion. However, in other embodiments, the amount-exceeding-credit-threshold service provider is contractually obligated and/or otherwise required to cover amounts exceeding a credit threshold incurred by an account.

In some embodiments, one or more portions of the process flow 100 may be configured to comply with one or more portions of a law, rule, and/or regulation that is directed to and/or otherwise relates to an amount exceeding a credit threshold (collectively referred to herein as “amount-exceeding-credit-threshold regulation” for simplicity). For example, in the United States, Regulation E regulates exceeding-available-funds services provided by financial institutions. Accordingly, it will be understood that some embodiments of the present invention enable a financial institution to comply with Regulation E, the CARD Act, and/or one or more other amount-exceeding-credit-threshold regulations. For example, in some embodiments, receiving the holder's consent to the future amount exceeding a credit threshold (and/or agreement to one or more terms of an amount-exceeding-credit-threshold service), as represented by block 110, may comply with one or more consent, opt-in, and/or revocation requirements of an amount-exceeding-credit-threshold regulation. As another example, in some embodiments, sending the holder a confirmation message that indicates the holder's consent to the future amount exceeding a credit threshold (and/or the one or more terms of the amount-exceeding-credit-threshold service) may comply with one or more confirmation requirements of an amount-exceeding-credit-threshold regulation.

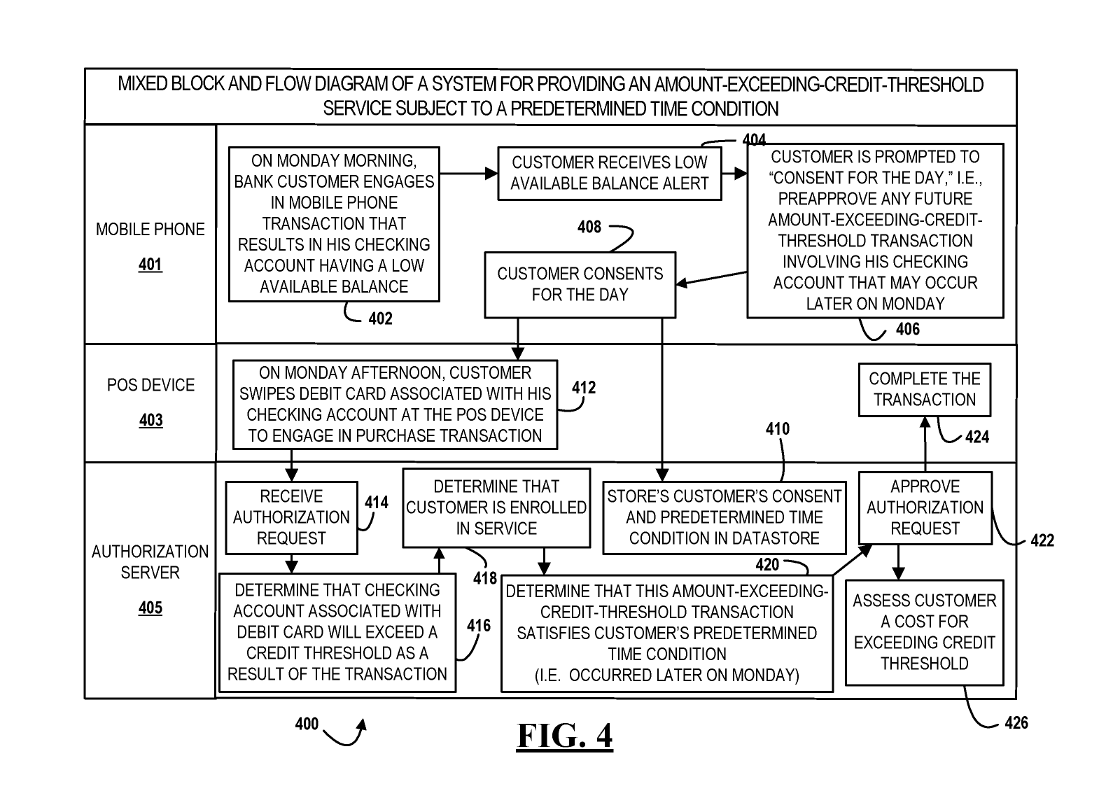

It will be understood that the apparatus having the process flow 100 can be configured to perform one or more portions of any embodiment described and/or contemplated herein, such as, for example, one or more portions of the process flow 200 described herein and/or one or more portions of the process flows described in connection with FIGS. 4 and/or 5. Also, the number, order, and/or content of the portions of the process flow 100 are exemplary and may vary. For example, in some embodiments, the apparatus having the process flow 100 is configured to assess a cost associated with the amount exceeding a credit threshold (e.g., assess an amount-exceeding-credit-threshold cost to the account and/or to the holder, and the like), where the cost is based at least partially on the account exceeding a credit threshold associated with the account, where the cost is based at least partially on the amount exceeding a credit threshold, and/or where the cost is assessed after authorizing and/or completing the transaction. In some embodiments, the apparatus is configured to: (a) assess the account an amount-exceeding-credit-threshold cost based at least partially on the apparatus determining that the account settled negative at the end of the day in which the transaction occurred; and/or (b) determine not to assess the account an amount-exceeding-credit-threshold cost based at least partially on the apparatus determining that the account settled non-negative (e.g., the account has a zero or positive available balance, and the like) at the end of the day in which the transaction occurred.

As another example, in some embodiments, the apparatus is configured to determine whether the holder has preapproved and/or otherwise consented to the amount exceeding a credit threshold referred to in block 130 and/or agreed to one or more terms of an amount-exceeding-credit-threshold service. As another example, in some embodiments, the apparatus is configured to determine whether the consent covers the transaction based at least partially on determining whether the predetermined condition is met. As still another example, in some embodiments, the apparatus is configured to authorize the transaction based at least partially on determining whether the holder consented to the amount exceeding a credit threshold and/or based at least partially on determining whether the consent is valid for the transaction. As still another example, in some embodiments, the apparatus is configured to send a confirmation message to the holder that confirms the holder's consent to the future amount exceeding a credit threshold and/or that indicates the one or more terms of the predetermined condition. As still another example, in some embodiments, the apparatus is configured to store (e.g., in a datastore, in an account profile associated with the account, in an online banking account, and the like) the holder's preapproval and/or consent to the future amount exceeding a credit threshold and/or information associated with the predetermined condition (e.g., the one or more terms of the predetermined condition), which may, in some embodiments, be required by one or more government and/or financial institution regulations (and/or one or more amount-exceeding-credit-threshold regulations).

As a further example, in some embodiments, the apparatus (and/or the transaction machine referred to in block 120) is configured to authenticate (e.g., confirm the identity of) the holder as a condition of authorizing the transaction. In some embodiments, the apparatus (and/or transaction machine) is configured to authenticate the holder based at least partially on account information (e.g., ATM/debit/credit card, account number, username, password, PIN, biometric information, barcode, and the like) the holder inserts, provides, and/or presents (collectively referred to herein as “presents” for simplicity) to the transaction machine and/or to the apparatus having the process flow 100. As another example, in some embodiments, the apparatus is configured to post transaction information associated with the transaction (e.g., the transaction information referred to in block 110, and the like) to an electronic banking account associated with the account.

As a further example, in some embodiments, the apparatus having the process flow 100 is configured to generate and/or send disclosure information to the holder (i.e., in addition to any disclosure information referred to in the process flow 100) before the apparatus receives the holder's consent to the future amount exceeding a credit threshold, before the amount-exceeding-credit-threshold transaction is initiated, before the holder approaches the transaction machine, and/or before the apparatus receives the transaction information. For example, in some embodiments, before the apparatus receives the holder's consent to the future amount exceeding a credit threshold, the apparatus is configured to generate and/or send disclosure information to the holder that defines one or more terms of an amount-exceeding-credit-threshold service, one or more predetermined conditions (and/or one or more terms thereof), and the like This disclosure information can be sent via one or more emails, telephone calls, text messages, instant messages, IVR communications, communications specific to one or more social media networks and/or applications, direct mailings, electronic banking account-specific messages, and/or the like. In some embodiments, the disclosure information is included in one or more communications typically sent to a holder, such as, for example, a periodic (e.g., monthly) account statement.

In some embodiments, sending the disclosure information to the holder may help a financial institution comply with one or more requirements of an amount-exceeding-credit-threshold regulation. For example, in some embodiments, the disclosure information includes information similar or identical to the information shown in the A-9 Model Consent Form for Overdraft Services, which is provided by the Federal Reserve at http://www.federalreserve.gov/DCCA/RegulationE/20081218/A-9.pdf and is incorporated herein by reference in its entirety. As such, the holder consenting to the future amount exceeding a credit threshold, as represented by block 110, can include the holder agreeing, electronically signing, and/or otherwise acknowledging that: (a) the holder has received the disclosure information; (b) the holder understands the one or more terms of the amount-exceeding-credit-threshold service defined in the disclosure information; (c) the holder agrees to the one or more terms of the amount-exceeding-credit-threshold service defined in the disclosure information (e.g., the holder enrolls in the amount-exceeding-credit-threshold service, and the like); (d) the holder agrees to the one or more predetermined conditions (and/or the one or more terms thereof) defined in the disclosure information; (e) the holder is already enrolled in the amount-exceeding-credit-threshold service; and/or (f) the holder agrees to use the amount-exceeding-credit-threshold service to complete the future amount-exceeding-credit-threshold transaction (e.g., subject to the predetermined condition). Similarly, the receiving the holder's consent to the future amount exceeding a credit threshold, as represented by block 110, can include receiving one or more of the holder's agreements, signatures, and/or other acknowledgements in response to the apparatus prompting the holder to indicate, make, give, and/or send those agreements, signatures, and/or other acknowledgements. In some embodiments, because the holder is sent the disclosure information, the receiving the holder's consent to the future amount exceeding a credit threshold may, individually or collectively, comply with one or more requirements of Regulation E and/or of one or more other amount-exceeding-credit-threshold regulations.

Furthermore, in some embodiments of the invention, the apparatus having the process flow 100 includes a memory device that has information stored therein about whether the holder has been mailed or otherwise sent amount-exceeding-credit-threshold service disclosure information prior to the transaction referred to in block 110. In some embodiments, the memory device additionally or alternatively stores information about whether the holder has enrolled in an amount-exceeding-credit-threshold service prior to the transaction referred to in block 110. In some such embodiments of the invention, the apparatus may condition authorizing the amount-exceeding-credit-threshold transaction based at least partially whether there is an indication in the memory device that the holder has already received the disclosure information and/or is already enrolled in the amount-exceeding-credit-threshold service.

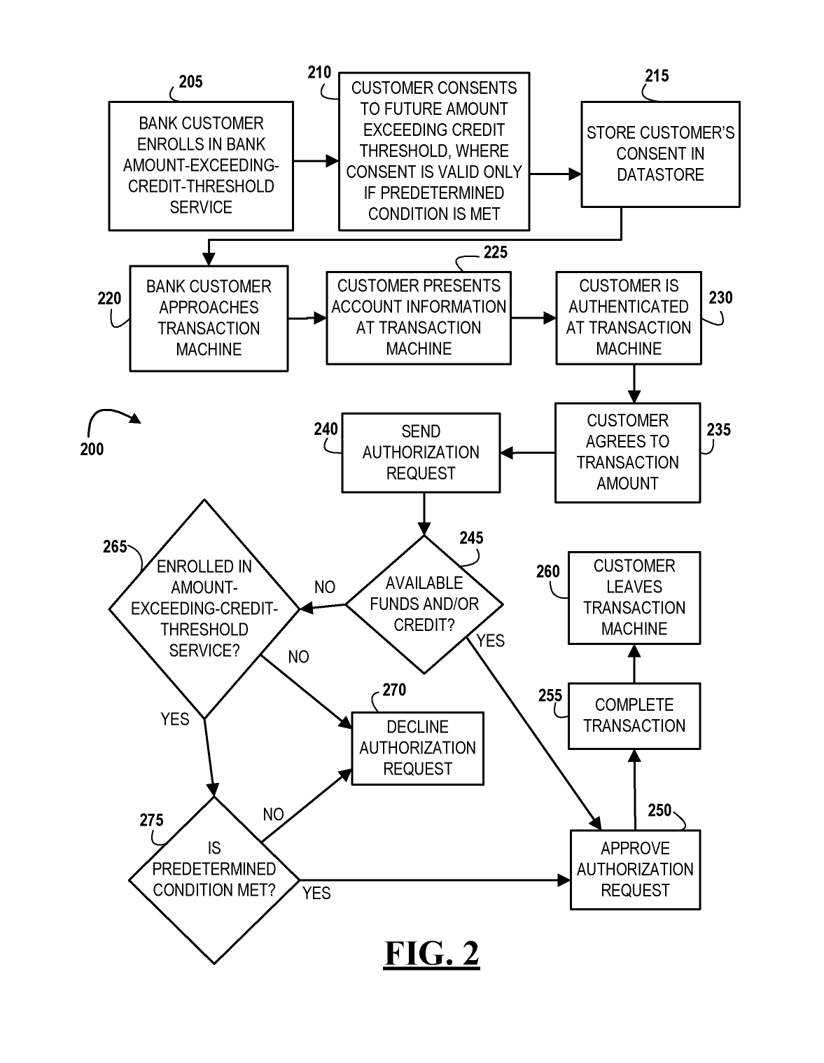

Referring now to FIG. 2, a more-detailed process flow 200 for providing an amount-exceeding-credit-threshold service subject to a customer-selected, predetermined condition is provided, in accordance with an embodiment of the present invention. It will be understood that the process flow 200 illustrated in FIG. 2 represents an example embodiment of the process flow 100 described in connection with FIG. 1. In accordance with some embodiments, one or more portions of the process flow 200 are performed by an apparatus (i.e., one or more apparatuses) having hardware and/or software configured to perform one or more portions of the process flow 200. The apparatus having the process flow 200 includes, is included in, is embodied as, and/or can be operatively connected to the transaction machine referred to in the process flow 200. In accordance with some embodiments, the apparatus having the process flow 200 is maintained by a bank for the benefit of its customers. Also in accordance with some embodiments, the customer referred to in the process flow 200 is the user of the transaction machine and a customer of the bank. In addition, the account (e.g., checking account, credit card account, and the like) referred to in the process flow 200 is an account held by the customer and maintained by the bank.

As represented by block 205, the bank customer enrolls in an amount-exceeding-credit-threshold service provided by the bank (e.g., via an online banking account, mobile phone, banking center, call center, amount-exceeding-credit-threshold preapproval machine 320, and the like). As represented by block 210, the customer also provides his consent to one or more future amounts exceeding a credit threshold, where the consent is valid only if a predetermined condition is met. For example, in some embodiments, the predetermined condition is such that the consent is valid only if the amount exceeding a credit threshold exceeds a predetermined amount. As with enrolling in the amount-exceeding-credit-threshold service, the customer may provide his consent in any way, such as, for example, via an online banking account associated with the account and/or by using an amount-exceeding-credit-threshold preapproval machine. After the customer's consent is provided, the apparatus having the process flow 200 is configured to store the customer's consent in a datastore (e.g., in an account profile associated with the account, which is stored in a computer readable medium, and the like), as represented by block 215. In some embodiments, storing the customer's consent also includes storing information associated with the predetermined condition (e.g., the one or more terms of the predetermined condition, and the like). It will be understood that, in some embodiments, the customer consents to the future amount exceeding a credit threshold when the customer enrolls in the amount-exceeding-credit-threshold service, but in other embodiments, the customer first enrolls in the amount-exceeding-credit-threshold service and then later consents to the future amount exceeding a credit threshold. In addition, in this example embodiment, the customer provides and/or selects the predetermined condition, but, in other embodiments, the predetermined condition can be selected for, and/or provided to, the customer. The predetermined condition (and/or one or more terms thereof) can be selected after the customer enrolls in the amount-exceeding-credit-threshold service.

After providing his consent to the future amount exceeding a credit threshold, the bank customer approaches the transaction machine for the purpose of engaging in a transaction using the transaction machine, as represented by block 220. After arriving at the transaction machine, the customer presents account information at the transaction machine, as represented by block 225. For example, in some embodiments where the transaction machine is a POS device, the customer may swipe a debit and/or credit card associated with the account through the POS device in order to communicate account information associated with the account to the POS device and/or to the apparatus having the process flow 200. As another example, in some embodiments where the transaction machine is a personal computer, the customer may input account information into a web page associated with the transaction that is displayed at the personal computer. After the account information is presented, the transaction machine (and/or the apparatus having the process flow 200) identifies and/or authenticates the customer, as represented by block 230. In some embodiments, the transaction machine authenticates the customer based at least partially on the account information (e.g., userid/password, PIN, checkcard, account number, and the like) the customer presents to the transaction machine.

After being authenticated, the customer selects the transaction and/or agrees to the transaction amount, as represented by block 235. Then, as represented by block 240, the transaction machine sends an authorization request to the apparatus having the process flow 200, where the authorization request identifies and/or describes the transaction, the customer, the account, and/or the like. Upon receiving the authorization request, the apparatus must determine whether the account has sufficient available funds and/or credit to cover the transaction, as represented by block 245. If so, then the apparatus, as represented by blocks 250 and 255, approves the authorization request and/or instructs the transaction machine to complete the transaction. After the transaction is completed at the transaction machine, the customer leaves the transaction machine, as represented by block 260.

However, if the apparatus having the process flow 200 determines that the account does not have sufficient available funds and/or credit to cover the transaction, then the apparatus is configured to determine whether the customer is enrolled in an amount-exceeding-credit-threshold service provided by the financial institution, as represented by block 265. If the customer is not enrolled in the amount-exceeding-credit-threshold service, then the apparatus having the process flow 200 (and/or the transaction machine) is configured decline the authorization request and/or otherwise decline, cancel, abort, and/or reject the transaction, as represented by block 270. Thus, in this example embodiment, the amount-exceeding-credit-threshold service cannot be used to complete the transaction if the holder is not already enrolled in the amount-exceeding-credit-threshold service prior to the transaction being initiated. However, other embodiments may be different. For example, in some embodiments, the apparatus is configured to enroll the customer in the amount-exceeding-credit-threshold service at some point during the transaction, such as, for example, after determining that the customer is not enrolled in the amount-exceeding-credit-threshold service and/or before the customer leaves the transaction machine.

Returning to FIG. 2, if the apparatus having the process flow 200 determines that the customer is enrolled in the amount-exceeding-credit-threshold service, then the apparatus is configured to determine whether the predetermined condition is met, as represented by block 275. In accordance with some embodiments, this condition determination is made after the apparatus determines that the customer is enrolled in the amount-exceeding-credit-threshold service. In some embodiments, the apparatus is configured to make the condition determination based at least partially on accessing the datastore (e.g., accessing the account profile associated with the customer's account, and the like) referred to in block 215, determining the one or more terms of the predetermined condition, and then comparing the one or more terms of the predetermined condition to transaction information associated with the transaction (e.g., the transaction amount referred to in block 235, the amount exceeding a credit threshold, the transaction machine referred to in block 230, and the like). Additionally or alternatively, in some embodiments, the apparatus having the process flow 200 is configured to make the condition determination based at least partially on comparing the one or more terms of the predetermined condition to the transaction history associated with the account (e.g., the number of instances the account exceeded a credit threshold associated with the account since the holder's consent was provided, and the like). If the predetermined condition is met, then the apparatus having the process flow 200 is configured to approve the authorization request, as represented by block 250. However, if the predetermined condition is not met, then the apparatus is configured to decline the authorization request, as represented by block 270. It will be understood that, in some embodiments, the customer does not know, during the transaction and/or while the customer is at the transaction machine, that the apparatus has determined whether the customer is enrolled in the amount-exceeding-credit-threshold service, whether the predetermined condition is met, and/or even whether the transaction is an amount-exceeding-credit-threshold transaction. However, in other embodiments, the apparatus having the process flow 200 is configured to send a message (e.g., an amount-exceeding-credit-threshold alert, an amount-exceeding-credit-threshold service use notification, and the like) to the customer (e.g., via a mobile phone carried by the customer, via the transaction machine being used to conduct the transaction, and the like) before and/or after the customer leaves the transaction machine.

Also, in some embodiments, one or more portions of the process flow 200 may comply with one or more requirements of an amount-exceeding-credit-threshold regulation (e.g., Regulation E and/or the CARD Act in the United States, and the like). For example, in some embodiments, receiving the customer's consent to the future amount exceeding a credit threshold, as represented by block 210, may comply with one or more consent requirements of an amount-exceeding-credit-threshold regulation. In addition, in some embodiments, approving the authorization request, as represented by block 250, may comply with one or more amount-exceeding-credit-threshold regulations because, for example, the customer gave his consent to the amount exceeding a credit threshold before the transaction that resulted in the amount exceeding a credit threshold was initiated and/or because the customer was authenticated by the transaction machine and/or by the apparatus having the process flow 200 before the authorization request was approved.

Of course, it will also be understood that the embodiment illustrated in FIG. 2 is merely exemplary and that other embodiments may vary without departing from the scope and spirit of the present invention. For example, in some embodiments, the apparatus having the process flow 200 is configured to provide funds and/or credit sufficient to complete the transaction. In such embodiments, the apparatus may provide the funds and/or credit to the account, the customer, and/or to the counterparty involved in the transaction (e.g., a merchant, and the like). Additionally or alternatively, in some embodiments, the apparatus may provide only the minimum amount of funds and/or credit needed to complete the transaction. In addition, the apparatus having the process flow 200 can be configured to perform one or more portions of the process flow 200 in real time, in substantially real time, and/or at one or more predetermined times. The apparatus having the process flow 200 may be configured to perform any of the portions of the process flow 200 represented by blocks 205-275 upon or after one or more triggering events (which, in some embodiments, is the performance of one or more of the other portions of the process flow 200). In addition, in some embodiments, the apparatus having the process flow 200 (and/or a customer thereof) is configured to perform each portion of the process flow 200, from start to finish, within moments, seconds, and/or minutes (e.g., within approximately 1-15 minutes, and the like).

Referring now to FIG. 3, a system 300 is illustrated for providing an amount-exceeding-credit-threshold service subject to one or more predetermined conditions, in accordance with an embodiment of the present invention. As illustrated, the system 300 includes a network 310, an amount-exceeding-credit-threshold preapproval machine 320, and an authorization apparatus 330. The system 300 also includes a personal computer 301, a banking center 302, a POS device 303, an ATM 304, a mobile phone 305, and a call center 306, which are sometimes collectively referred to herein as “the channels 301-306” for simplicity. FIG. 3 also shows an account holder 308 and an account 307. The account 307 (e.g., credit account, deposit account, and the like) is associated with an electronic banking account 309 (e.g., online banking account, mobile banking account, text banking account, and the like). As shown, the holder 308 has access to the amount-exceeding-credit-threshold preapproval machine 320 and the channels 301-306. In accordance with some embodiments, the amount-exceeding-credit-threshold preapproval machine 320, the authorization apparatus 330, and one or more of the channels 301-306 are each maintained by the same financial institution. For example, in some embodiments, the holder 308 is a customer of the financial institution, the authorization apparatus 330 is embodied as an ATM transaction server maintained by the financial institution, the ATM 304 is maintained by the financial institution, and the amount-exceeding-credit-threshold preapproval machine 320 is embodied as a banking center kiosk maintained by the financial institution. However, in other embodiments, the amount-exceeding-credit-threshold preapproval machine 320 and the authorization apparatus 330 are maintained by separate entities. For example, in some embodiments, the authorization apparatus 330 is maintained by a bank, and the amount-exceeding-credit-threshold preapproval machine 320 is associated with the holder 308 and/or is carried, owned, possessed, and/or owned by the holder 308.

As shown in FIG. 3, the amount-exceeding-credit-threshold preapproval machine 320, the authorization apparatus 330, and the channels 301-306 are each operatively and selectively connected to the network 310, which may include one or more separate networks. The network 310 may include one or more payment networks (e.g., interbank networks, credit card payment networks, any wireline and/or wireless network over which payment information is sent, and the like), telephone networks (e.g., cellular networks, CDMA networks, any wireline and/or wireless network over which communications to telephones and/or mobile phones are sent, and the like), local area networks (LANs), wide area networks (WANs), global area networks (GANs) (e.g., the Internet, and the like), and/or one or more other telecommunications networks. For example, in some embodiments, the network 310 includes a telephone network (e.g., for communicating with the amount-exceeding-credit-threshold preapproval machine 320, the mobile phone 305, and the like) and a payment network (e.g., for communicating with the amount-exceeding-credit-threshold preapproval machine 320, the POS device 303, the ATM 304, and the like). It will also be understood that the network 310 may be secure and/or unsecure and may also include wireless and/or wireline technology.

The amount-exceeding-credit-threshold preapproval machine 320 may include any computerized apparatus that can be configured to perform any one or more of the functions of the amount-exceeding-credit-threshold preapproval machine 320 described and/or contemplated herein. It will also be understood that the amount-exceeding-credit-threshold preapproval machine 320 can include and/or be embodied as, any transaction machine described and/or contemplated herein, such as, for example, a personal computer, ATM, POS device, gaming device, mobile device (e.g., mobile phone, tablet computer, PDA, portable gaming device, and the like), banking center kiosk, module, front end system, back end system, network device, and the like Thus, it will be understood that, in some embodiments, the amount-exceeding-credit-threshold preapproval machine 320 is the same type of machine as the personal computer 301, the POS device 303, the ATM 304, and/or the mobile phone 305. (In some of these embodiments, the amount-exceeding-credit-threshold preapproval machine 320 is the personal computer 301, the POS device 303, the ATM 604, and/or the mobile phone 305.) In some embodiments, the amount-exceeding-credit-threshold preapproval machine 320 is configured to initiate, perform, complete, and/or otherwise facilitate one or more financial and/or non-financial transactions, including, for example, purchasing, renting, selling, and/or leasing goods and/or services (e.g., groceries, stamps, tickets, gift certificates, DVDs, and the like); withdrawing cash; making deposits (e.g., cash, checks, and the like); making payments (e.g., paying telephone bills, sending remittances, and the like); accessing the Internet; enrolling in amount-exceeding-credit-threshold services; communicating preapproval and/or consent to one or more future amounts exceeding a credit threshold; selecting predetermined conditions associated with that preapproval and/or consent; and/or the like.

As illustrated in FIG. 3, in accordance with some embodiments of the present invention, the amount-exceeding-credit-threshold preapproval machine 320 includes a communication interface 322, a processor 324, a memory 326 having a preapproval application 327 stored therein, and a user interface 329. In such embodiments, the processor 324 is operatively and selectively connected to the communication interface 322, the user interface 329, and the memory 326.

Each communication interface described herein, including the communication interface 322, generally includes hardware, and, in some instances, software, that enables a portion of the system 300, such as the amount-exceeding-credit-threshold preapproval machine 320, to send, receive, and/or otherwise communicate information to and/or from the communication interface of one or more other portions of the system 300. For example, the communication interface 322 of the amount-exceeding-credit-threshold preapproval machine 320 may include a modem, network interface controller (NIC), near field communication (NFC) interface, network adapter, network interface card, and/or some other electronic communication device that operatively connects the amount-exceeding-credit-threshold preapproval machine 320 to another portion of the system 300, such as, for example, the authorization apparatus 330.

Each processor described herein, including the processor 324, generally includes circuitry for implementing the audio, visual, and/or logic functions of that portion of the system 300. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the preapproval application 327 of the memory 326 of the amount-exceeding-credit-threshold preapproval machine 320.

Each memory device described herein, including the memory 326 for storing the preapproval application 327 and other information, may include any computer-readable medium. For example, the memory may include volatile memory, such as volatile random access memory (RAM) having a cache area for the temporary storage of data. Memory may also include non-volatile memory, which may be embedded and/or may be removable. The non-volatile memory may additionally or alternatively include an EEPROM, flash memory, and/or the like. The memory may store any one or more of portions of information used by the apparatus in which it resides to implement the functions of that apparatus.

As shown in FIG. 3, the memory 326 includes the preapproval application 327. It will be understood that the preapproval application 327 can be operable (e.g., usable, executable, and the like) to initiate, perform, complete, and/or otherwise facilitate one or more portions of any embodiment described and/or contemplated herein, such as, for example, one or more portions of the process flows 100 and/or 200 described herein and/or one or more portions of the process flows described in connection with FIGS. 4 and/or 5. For example, in some embodiments, the preapproval application 327 is operable to enroll the holder 308 in the amount-exceeding-credit-threshold service (e.g., via the electronic banking account 309) and/or to enable the holder 308 to preapprove (and/or otherwise consent to) one or more future amount-exceeding-credit-threshold transactions and/or amount-exceeding-credit-threshold costs associated with those future amount-exceeding-credit-threshold transactions. In some embodiments, the holder's 308 preapproval is valid only if a predetermined condition is met. For example, in some embodiments, the predetermined condition relates to the future amount-exceeding-credit-threshold transaction, such that the holder's 308 preapproval is valid only if the future amount-exceeding-credit-threshold transaction is initiated during a predetermined period of time. In some embodiments, the holder 308 selects the predetermined condition, but in other embodiments, the preapproval application 327 selects the predetermined condition for the holder 308, for example, when the holder 308 enrolls in the amount-exceeding-credit-threshold service.

In some embodiments, the preapproval application 327 is operable to prompt the holder 308, via the user interface 329, to enroll in the amount-exceeding-credit-threshold service, agree to one or more terms of the amount-exceeding-credit-threshold service, and/or select one or more predetermined conditions. Additionally or alternatively, in some embodiments, the preapproval application 327 is operable to prompt, via the user interface 329, the holder 308 to consent to a future amount exceeding a credit threshold, to incurring an amount-exceeding-credit-threshold cost associated with that future amount exceeding a credit threshold, to using an amount-exceeding-credit-threshold service to cover that future amount exceeding a credit threshold, and/or to one or more terms of an amount-exceeding-credit-threshold service. In some of these embodiments, the preapproval application 327 is also operable to receive, via the user interface 329, the holder's 302 consent to the future amount exceeding a credit threshold, to incurring an amount-exceeding-credit-threshold cost associated with the future amount exceeding a credit threshold, to using the amount-exceeding-credit-threshold service to cover the future amount exceeding a credit threshold, and/or to the one or more terms of the amount-exceeding-credit-threshold service. In some embodiments, where the amount-exceeding-credit-threshold preapproval machine 320 includes and/or is embodied as a personal computer, the preapproval application 327 is configured to execute on the personal computer, and in some embodiments, the preapproval application 327 is embodied as a web browser (i.e., for navigating the Internet, for accessing online banking accounts, and the like).

In some embodiments, where the amount-exceeding-credit-threshold preapproval machine 320 is also a transaction machine, the preapproval application 327 is operable to receive transaction information associated with a transaction. In some embodiments, the preapproval application 327 is operable to determine, based at least partially on transaction information, that an account (e.g., the account 307, and the like) will exceed a credit threshold associated with the account as a result of a transaction. In some embodiments, the preapproval application 327 is operable to determine whether one or more predetermined conditions are met and/or whether the holder's 308 consent is valid. In still further embodiments, the preapproval application 327 is operable to authorize one or more transactions, for example, based at least partially on determining that a predetermined condition is met, on determining that the holder's 308 consent is met, and/or on receiving a holder's consent (e.g., to authorize the transaction). In some embodiments, the preapproval application 327 is operable to complete one or more transactions at the preapproval machine 320 (e.g., complete a purchase transaction, dispense cash, accept a check for deposit, and the like).

In some embodiments, the preapproval application 327 is operable to enable the holder 308 and/or amount-exceeding-credit-threshold preapproval machine 320 to communicate with one or more other portions of the system 300, and/or vice versa. In some embodiments, the preapproval application 327 is additionally or alternatively operable to initiate, perform, complete, and/or otherwise facilitate one or more financial and/or non-financial transactions. In some embodiments, the preapproval application 327 includes one or more computer-executable program code portions for causing and/or instructing the processor 324 to perform one or more of the functions of the preapproval application 327 and/or amount-exceeding-credit-threshold preapproval machine 320 described and/or contemplated herein. In some embodiments, the preapproval application 327 includes and/or uses one or more network and/or system communication protocols.

In some embodiments, the amount-exceeding-credit-threshold preapproval machine 320 and/or the preapproval application 327 (and/or one or more other portions of the system 300) requires its users to authenticate themselves to the amount-exceeding-credit-threshold preapproval machine 320 before the amount-exceeding-credit-threshold preapproval machine 320 will initiate, perform, complete, and/or facilitate a transaction. For example, in some embodiments, the amount-exceeding-credit-threshold preapproval machine 320 (and/or the preapproval application 327) is configured to authenticate a machine user based at least partially on an ATM/debit/credit card, loyalty/rewards/club card, smart card, token (e.g., USB token, and the like), username/password, personal identification number (PIN), biometric information, and/or one or more other credentials that the user presents to the amount-exceeding-credit-threshold preapproval machine 320. Additionally or alternatively, in some embodiments, the amount-exceeding-credit-threshold preapproval machine 320 is configured to authenticate a user by using one-, two-, or multi-factor authentication. For example, in some embodiments, the amount-exceeding-credit-threshold preapproval machine 320 requires two-factor authentication, such that the holder 308 must provide a valid password and iris scan to authenticate the holder 308 to the amount-exceeding-credit-threshold preapproval machine 320.

As shown in FIG. 3, the amount-exceeding-credit-threshold preapproval machine 320 also includes the user interface 329. It will be understood that the user interface 329 (and any other user interface described and/or contemplated herein) can include and/or be embodied as one or more user interfaces. It will also be understood that, in some embodiments, the user interface 329 includes one or more user output devices for presenting information and/or one or more items to the amount-exceeding-credit-threshold preapproval machine user (e.g., the holder 308, and the like), such as, for example, one or more displays, speakers, receipt printers, dispensers (e.g., cash dispensers, ticket dispensers, merchandise dispensers, and the like), and/or the like. In some embodiments, the user interface 329 additionally or alternatively includes one or more user input devices, such as, for example, one or more buttons, keys, dials, levers, directional pads, joysticks, keyboards, mouses, accelerometers, controllers, microphones, touchpads, touchscreens, haptic interfaces, styluses, scanners, biometric readers, motion detectors, cameras, card readers (e.g., for reading the magnetic strip on magnetic cards such as ATM, debit, credit, and/or bank cards, and the like), deposit mechanisms (e.g., for depositing checks and/or cash, and the like), and/or the like for receiving information from one or more items and/or from the amount-exceeding-credit-threshold preapproval machine user (e.g., the holder 308, and the like). In some embodiments, the user interface 329 and/or the amount-exceeding-credit-threshold preapproval machine 320 includes one or more vaults, security sensors, locks, and/or anything else typically included in and/or near a transaction machine.

FIG. 3 also illustrates an authorization apparatus 330, in accordance with an embodiment of the present invention. The authorization apparatus 330 may include any computerized apparatus that can be configured to perform any one or more of the functions of the authorization apparatus 330 described and/or contemplated herein. It will also be understood that the authorization apparatus 330 can include and/or be embodied as any authorization apparatus described and/or contemplated herein. It will further be understood that the authorization apparatus 330 can initiate, perform, complete, and/or otherwise facilitate any transaction described and/or contemplated herein as being initiated, performed, and/or otherwise facilitated by an authorization apparatus. In some embodiments, the authorization apparatus 330 includes and/or is embodied as one or more servers, engines, mainframes, personal computers, ATMs, network devices, front end systems, back end systems, and/or the like. In some embodiments, such as the one illustrated in FIG. 3, the authorization apparatus 330 includes a communication interface 332, a processor 334, and a memory 336, which includes an authorization application 337 and an authorization datastore 338 stored therein. As shown, the communication interface 332 is operatively and selectively connected to the processor 334, which is operatively and selectively connected to the memory 336.

The authorization application 337 can be operable (e.g., usable, executable, and the like) to initiate, perform, complete, and/or otherwise facilitate any one or more portions of the process flows 100 and/or 200 described herein and/or one or more portions of the process flows described in connection with FIGS. 4 and/or 5. For example, in some embodiments, the authorization application 337 is operable to receive, via the user interface 329 of the amount-exceeding-credit-threshold preapproval machine 320, the holder's 308 consent to one or more future amounts exceeding a credit threshold, where the holder's 308 consent is valid only if one or more predetermined conditions are met. As another example, in some embodiments, the authorization application 337 is operable to receive transaction information associated with a transaction, where the transaction involves the holder 308, the account 307, and/or one or more of the channels 301-306. As still another example, in some embodiments, the authorization application 337 is operable to determine, based at least partially on transaction information, that an account (e.g., the account 307) will exceed a credit threshold associated with the account as a result of a transaction. As another example, in some embodiments, the authorization application 337 is operable to determine whether one or more predetermined conditions are met and/or whether the holder's 308 consent is valid. As still another example, in some embodiments, the authorization application 337 is operable to authorize and/or complete one or more transactions. Also, in some embodiments, the authorization application 337 is further operable to prompt the holder 308 (e.g., via the user interface 329 of the amount-exceeding-credit-threshold preapproval machine 320, via the user interface of the mobile phone 305, during the amount-exceeding-credit-threshold transaction, and the like) to agree to the one or more terms of an amount-exceeding-credit-threshold service and/or to one or more predetermined conditions. In some embodiments, the authorization application 337 is operable to perform one or more of these (and/or other) functions, such that a financial institution may comply with one or more amount-exceeding-credit-threshold regulation requirements (e.g., Regulation E in the United States, and the like).

In some embodiments, the authorization application 337 is operable to enable the authorization apparatus 330 to communicate with one or more other portions of the system 300, such as, for example, the authorization datastore 338, the mobile device 305, and/or the amount-exceeding-credit-threshold preapproval machine 320, and/or vice versa. In addition, in some embodiments, the authorization application 337 is operable to initiate, perform, complete, and/or otherwise facilitate one or more financial and/or non-financial transactions. In some embodiments, the authorization application 337 includes one or more computer-executable program code portions for causing and/or instructing the processor 334 to perform one or more of the functions of the authorization application 337 and/or the authorization apparatus 330 that are described and/or contemplated herein. In some embodiments, the authorization application 337 includes and/or uses one or more network and/or system communication protocols.

In addition to the authorization application 337, the memory 336 also includes the authorization datastore 338. It will be understood that the authorization datastore 338 can be configured to store any type and/or amount of information. For example, in some embodiments, the authorization datastore 338 includes information associated with one or more amount-exceeding-credit-threshold preapproval machines, amount-exceeding-credit-threshold preapproval machine users, transaction machines, transaction machine users, transactions, amounts exceeding a credit threshold, predetermined conditions, financial accounts, electronic banking accounts, mobile phones, amount-exceeding-credit-threshold services, authorization requests, amount-exceeding-credit-threshold regulations, and/or the like. In some embodiments, the authorization datastore 338 may also store any information related to providing an amount-exceeding-credit-threshold service subject to one or more predetermined conditions. In some embodiments, the authorization datastore 338 additionally or alternatively stores information associated with electronic banking and/or electronic banking accounts.

In accordance with some embodiments, the authorization datastore 338 may include any one or more storage devices, including, but not limited to, datastores, databases, and/or any of the other storage devices typically associated with a computer system. It will also be understood that the authorization datastore 338 may store information in any known way, such as, for example, by using one or more computer codes and/or languages, alphanumeric character strings, data sets, figures, tables, charts, links, documents, and/or the like. Further, in some embodiments, the authorization datastore 338 includes information associated with one or more applications, such as, for example, the authorization application 337 and/or the preapproval application 327. In some embodiments, the authorization datastore 338 provides a real-time or near real-time representation of the information stored therein, so that, for example, when the processor 334 accesses the authorization datastore 338, the information stored therein is current or nearly current. Although not shown, in some embodiments, the amount-exceeding-credit-threshold preapproval machine 320 includes a preapproval datastore that is configured to store any information associated with the amount-exceeding-credit-threshold preapproval machine 320, the preapproval application 327, and/or the like. It will be understood that the preapproval datastore can store information in any known way, can include information associated with anything shown in FIG. 3, and/or can be configured similar to the authorization datastore 338.

The embodiment illustrated in FIG. 3 is exemplary and other embodiments may vary. For example, in some embodiments, some or all of the portions of the system 300 are combined into a single portion. Specifically, in some embodiments, the amount-exceeding-credit-threshold preapproval machine 320 and the authorization apparatus 330 are combined into a single preapproval and authorization apparatus that is configured to perform all of the same functions of those separate portions as described and/or contemplated herein. As another example, in some embodiments, the amount-exceeding-credit-threshold preapproval machine 320 and the mobile phone 305 (or the ATM 304) are combined into a single mobile phone (or ATM) that is configured to perform all of the same functions of those separate portions as described and/or contemplated herein. Likewise, in some embodiments, some or all of the portions of the system 300 are separated into two or more distinct portions. In addition, the various portions of the system 300 may be maintained by the same or separate parties.

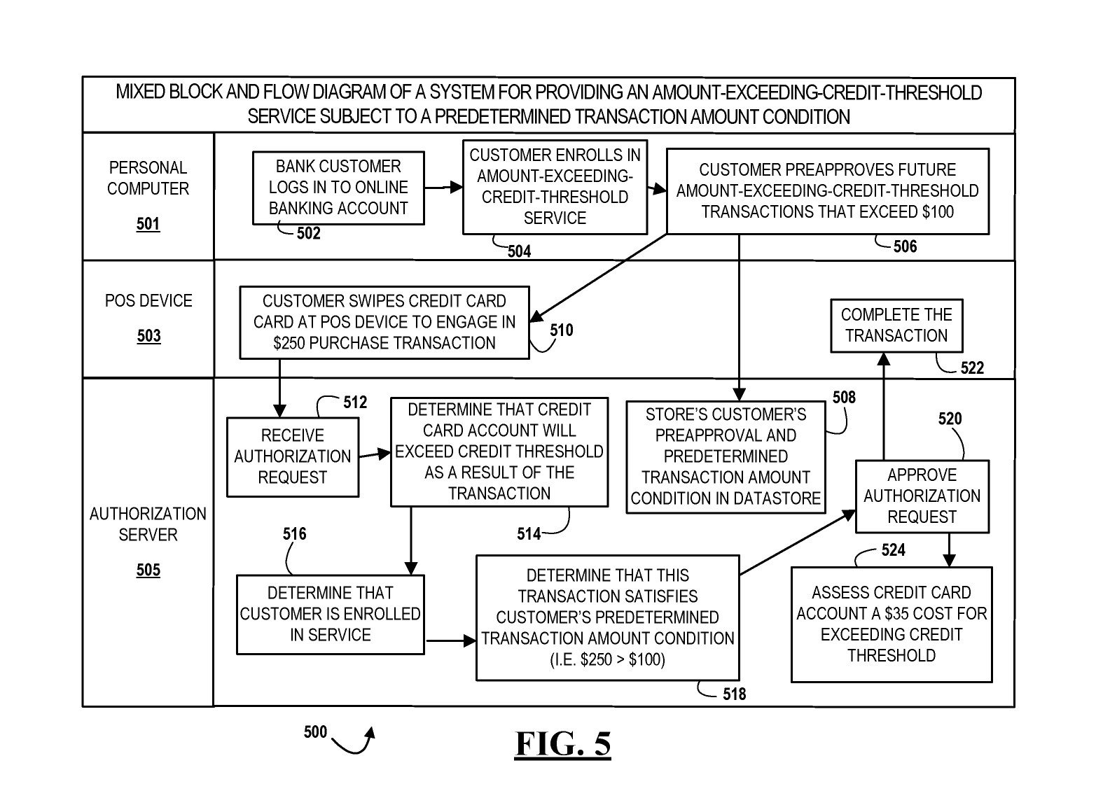

The system 300 and/or one or more portions of the system 300 may include and/or implement any embodiment of the present invention described and/or contemplated herein. For example, in some embodiments, the system 300 (and/or one or more portions of the system 300) is configured to implement any one or more embodiments of the process flow 100 described and/or contemplated herein in connection with FIG. 1, any one or more embodiments of the process flow 200 described and/or contemplated herein in connection with FIG. 2, any one or more embodiments of the process flow described and/or contemplated herein in connection with FIG. 4, and/or any one or more of embodiments of the process flow described and/or contemplated herein in connection with FIG. 5.

As a specific example, in accordance with an embodiment of the present invention, the authorization apparatus 330 is configured to: (a) receive, from the holder 308 of the account 307 and via the amount-exceeding-credit-threshold preapproval machine 320, consent to a future amount exceeding a credit threshold, where the future amount exceeding a credit threshold is a result of a future amount-exceeding-credit-threshold transaction involving the account 307, and where the consent is only valid if a predetermined condition is met, as represented by block 110 in FIG. 1; (b) receive transaction information associated with a transaction, where the transaction involves the account 307, the holder 308, and a transaction machine (e.g., any of the channels 301-306, and the like), and where the transaction was initiated after receiving the holder's 302 consent to the future amount exceeding a credit threshold, as represented by block 120; (c) determine, based at least partially on the transaction information, that the account 307 will exceed a credit threshold associated with the account as a result of the transaction, as represented by block 130; (d) determine that the predetermined condition is met and/or that the holder's 308 consent is valid for (e.g., covers) the transaction (e.g., based at least partially on the transaction information), as represented by block 140; and (e) authorize the transaction based at least partially on receiving the holder's 308 consent, determining that the holder's 308 consent is valid for the transaction, and/or determining that the predetermined condition is met, as represented by block 150. In accordance with some embodiments, the amount-exceeding-credit-threshold preapproval machine 320, the authorization apparatus 330, and/or one or more of the channels 301-306 are each configured to send and/or receive one or more instructions to and/or from each other, such that an instruction sent, for example, from the amount-exceeding-credit-threshold preapproval machine 320 to the authorization apparatus 330 (and/or vice versa) can trigger the authorization apparatus 330 (and/or vice versa) to perform one or more portions of any one or more of the embodiments described and/or contemplated herein.

Referring now to FIG. 4, a mixed block and flow diagram of a system 400 is illustrated for providing an exceeding-available-funds service subject to a predetermined time condition, in accordance with an exemplary embodiment of the present invention. It will be understood that the system 400 illustrated in FIG. 4 represents an example embodiment of the process flow 200 described in connection with FIG. 2. As shown, the system 400 includes a mobile phone 401 (e.g., the mobile phone 305, the amount-exceeding-credit-threshold preapproval machine 320, and the like), a POS device 403 (e.g., the POS device 303, and the like), and an authorization server 405 (e.g., the authorization apparatus 330, and the like). The mobile phone 401, POS device 403, and authorization server 405 may each include a communication interface, a user interface, a processor, a memory, an application, and/or a datastore, and those components may be operatively connected to each other.

In accordance with some embodiments, the mobile phone 401 and the POS device 403 are each operatively and selectively connected to the authorization server 405 via one or more networks. For example, in some embodiments, the mobile phone 401 is operatively connected to the authorization server 405 via one or more telephone networks, and/or the POS device 403 is operatively connected to the authorization server 405 via one or more payment networks. In this example embodiment, the mobile phone 401 and the POS device 403 are accessible to a customer of a financial institution. The customer is also a holder of the checking account mentioned in FIG. 4, the checking account is associated with the debit card mentioned in FIG. 4, and the financial institution maintains the checking account held by the customer. Also, it will be understood that, in this example embodiment, the customer and/or the checking account are enrolled in an exceeding-available-funds service before the process flow represented by blocks 402-426 is performed. In addition, the mobile phone 401 is maintained by the customer, the POS device 403 is maintained by a merchant, and the authorization server 405 is maintained by the financial institution. Also, in this example embodiment, the portions of the process flow represented by blocks 402-426 all occur during a single day (e.g., in this example embodiment, the process flow occurs on “Monday”).

As represented by block 402, on Monday morning, the customer uses the mobile phone 401 to engage in a mobile phone transaction that results in his checking account having a low available balance. In other words, as a result of the mobile phone transaction, the available balance for the checking account falls below a predetermined threshold (e.g., $100, $20, and the like). In some embodiments, the customer and/or the financial institution may select, assign, set, and/or otherwise determine the predetermined threshold for the checking account, and this determining may occur, for example, when the customer opens the account and/or before the customer engages in the mobile phone transaction. Thereafter, as represented by block 404, the authorization server 405 determines that the available balance for the checking account has fallen below the predetermine threshold, and then the authorization server 405 generates and/or sends a low available balance alert to the customer via the mobile phone 401. In some embodiments, the low balance alert received by the mobile phone 401 is delivered visually to the customer via a display of the mobile phone 401 and/or audibly via a speaker of the mobile phone 401. For example, in some embodiments, the customer receives, via the mobile phone 401, an SMS message from the authorization server 405, where the SMS message indicates that the customer's available balance has fallen below the predetermined threshold.

In addition, as represented by block 406, the authorization server 405 also prompts the customer, via the mobile phone 401, to “consent for the day,” i.e., the customer is asked to preapprove any exceeding-available-funds transaction involving his checking account that may occur later on Monday. In other words, the customer is asked to consent to the financial institution and/or the authorization server 405 using the exceeding-available-funds service to complete one or more future exceeding-available-funds transactions involving his checking account that may occur on Monday. Additionally or alternatively, in some embodiments, the customer also preapproves being assessed an exceeding-available-funds cost if his checking account engages in an exceeding-available-funds transaction later on Monday and/or if his checking account remains overdrawn at the end of the day on Monday.

It will be understood that, in this example embodiment, the customer's consent is only valid for Monday. In other words, in this embodiment, if the customer engages in an exceeding-available-funds transaction on Tuesday (e.g., the Tuesday immediately after the Monday referred to in FIG. 4), the customer's consent referred to in blocks 406 and 408 will not be valid for the Tuesday transaction, the customer cannot be assessed an exceeding-available-funds cost associated with the Tuesday transaction (e.g., in accordance with an exceeding-available-funds regulation), and/or the Tuesday transaction will be declined (unless, of course, the customer provides additional consent to cover the Tuesday exceeding-available-funds transaction). Also, although shown as different blocks 404 and 406, it will be understood that the low balance alert and the prompting the customer to consent for the day can be combined into a single communication that is sent from the authorization server 405 to the mobile phone 401 (e.g., via a telephone network). Also, for simplicity, the predetermined condition placed on the customer's consent (i.e., that the consent is only valid for the rest of the day on Monday) is sometimes referred to herein as the “predetermined time condition.”

After receiving the low balance alert and/or being prompted by the authorization server 405, the customer consents for the day via the mobile phone 401 (and/or via a telephone network), as represented by block 408. For example, in some embodiments, the customer uses one or more buttons, styluses, and/or other user input devices provided by the mobile phone 401 (and/or by an application executing on the mobile phone 401) to indicate his consent to future amounts exceeding available funds involving his checking account that occur later on Monday. In some embodiments, by consenting for the day, the customer agrees to: (a) use the exceeding-available-funds service to complete one or more exceeding-available-funds transactions involving the checking account that occur later on Monday; (b) incur an exceeding-available-funds cost for using the exceeding-available-funds service later on Monday; (c) incur an exceeding-available-funds cost if the checking account remains overdrawn at the end of the day on Monday; and/or (d) the one or more terms of the exceeding-available-funds service if the service is used on Monday to complete an exceeding-available-funds transaction involving the checking account.

After the customer consents for the day, the authorization server 405 stores the customer's preapproval and/or the one or more terms of the predetermined time condition in a datastore, as represented by block 410. In some embodiments, these items are stored in an account profile in the datastore, where the account profile is associated with the customer's account. In addition, on Monday afternoon, after the customer consents for the day, the customer swipes his checking account debit card at the POS device 403 to engage in a purchase transaction, as represented by block 412. Although not shown, in some embodiments, the POS device 403 may also authenticate the customer based at least partially on one or more credentials (e.g., PIN, and the like) the customer provides to the POS device 403. Next, as represented by block 414, the POS device 403 generates and/or sends an authorization request associated with the purchase transaction to the authorization server 405. In accordance with some embodiments, the authorization request includes information that, for example, identifies the customer, the checking account associated with the debit card, the amount of the transaction, the one or more goods and/or services involved in the transaction, and/or the like. As represented by block 416, the authorization server 405 then determines that the checking account will exceed available funds as a result of the transaction.

After making the exceeding-available-funds determination, the authorization server 405 determines that the customer is enrolled in the exceeding-available-funds service provided by the financial institution, as represented by block 418. Thereafter, as represented by block 420, the authorization server 405 determines that the purchase transaction is an exceeding-available-funds transaction that satisfies the customer's predetermined time condition. In other words, in some embodiments, the authorization server 405 determines that customer's consent referred to in block 406 is valid for the purchase transaction referred to in block 412 based at least partially on determining that the purchase transaction is an exceeding-available-funds transaction that occurred on Monday after the customer provided his consent. In some embodiments, the authorization server 405 makes the condition determination based at least partially on comparing the transaction information associated with the purchase transaction to the one or more terms of the customer's predetermined time condition stored in the datastore. Thereafter, the authorization server 405 approves the authorization request, as represented by block 422, based at least partially on determining that the purchase transaction satisfied the predetermined time condition, on determining that the customer's consent is valid for the transaction, and/or on determining that the customer consented for the day. Thereafter, as represented by block 424, the transaction is completed at the POS device 403. In addition, as represented by block 426, the authorization server 405 assesses the customer (and/or the customer's checking account) an exceeding-available-funds cost for exceeding available funds in his checking account. Although not shown, the authorization server 405 can be additionally or alternatively configured to assess the customer an overdraft cost if the customer's checking account remains overdrawn at the end of the day on Monday.

Of course, the embodiment illustrated in FIG. 4 is merely exemplary and other embodiments may vary without departing from the scope and spirit of the present invention. For example, in some embodiments, one or more portions of the process flow being performed by the authorization server 405 are performed instead by the POS device 403, or vice versa. As another example, in some alternative embodiments, instead of consenting for the day, the customer may preapprove only two exceeding-available-funds transactions for a particular month, and the authorization server 405 may approve the authorization request referred to in block 422 based at least partially on determining that the purchase transaction referred to in block 412 constitutes the first exceeding-available-funds transaction involving the checking account in that particular month. As another example, in some alternative embodiments of the present invention, instead of involving a debit card, a checking account, a debit card transaction, and/or an exceeding-available-funds service, the process flow shown in FIG. 4 involves a credit card, a credit card account, a credit card transaction, and/or an amount-exceeding-credit-threshold service.

Also, in some embodiments, one or more of the portions of the process flow represented by blocks 402-426 are triggered by one or more triggering events, which, in some embodiments, include the performance of one or more of the other portions of the process flow represented by blocks 402-426. Also, in some embodiments, the system 400 is configured to perform the entire process flow represented by blocks 402-426, from start to finish, within moments, seconds, and/or minutes. For example, in some embodiments, the authorization server 405 approves the authorization request within approximately 1-5 minutes of the authorization server 405 receiving the authorization request from the POS device 403. Further, it will be understood that one or more portions of the process flow represented by blocks 402-426 are configured to comply with one or more requirements of an exceeding-available-funds regulation (e.g., Regulation E in the United States).

Referring now to FIG. 5, a mixed block and flow diagram of a system 500 is illustrated for providing an amount-exceeding-credit-threshold service subject to a predetermined transaction amount condition, in accordance with an exemplary embodiment of the present invention. It will be understood that the system 500 illustrated in FIG. 5 represents an example embodiment of the process flow 200 described in connection with FIG. 2. As shown, the system 500 includes a personal computer 501, a POS device 503 (e.g., merchant terminal, and the like), and an authorization server 505 (e.g., the authorization apparatus 330, and the like). The personal computer 501, the POS device 503, and the authorization server 505 may each include a communication interface, a user interface, a processor, a memory, an application, and/or a datastore, and those components may be operatively connected to each other.

In accordance with some embodiments, the personal computer 501 and the POS device 503 are operatively and selectively connected to the authorization server 505 via one or more networks. For example, in some embodiments, the personal computer 501 is operatively connected to the authorization server 505 via the Internet, and/or the POS device 503 is operatively connected to the authorization server 505 via a payment network. In this example embodiment, the personal computer 501 and the POS device 503 are accessible to a customer of a financial institution. The customer is also a holder of the credit card account mentioned in FIG. 5, the credit card account is associated with the credit card mentioned in FIG. 5, and the financial institution maintains the credit card account held by the customer. It will be understood that, in this example embodiment, the personal computer 501 is maintained by the customer, the POS device 503 is maintained by a merchant, and the authorization server 505 is maintained by the financial institution.

As represented by block 502, the customer logs in to an online banking account accessible through the personal computer 501. In some embodiments, the online banking application authenticates the customer before providing the customer access to the online banking account. In some embodiments, the online banking application authenticates the customer based at least partially on one or more credentials provided by the customer to the application (e.g., username, password, account number, PIN, and the like). After logging in, the customer enrolls in an amount-exceeding-credit-threshold service provided by the financial institution. During or after enrollment, the customer preapproves future amount-exceeding-credit-threshold transactions that exceed $100. In other words, the customer consents to the financial institution and/or the authorization server 505 using the amount-exceeding-credit-threshold service to complete one or more future amount-exceeding-credit-threshold transactions involving his checking account that have a transaction amount greater than $100. Additionally or alternatively, in some embodiments, the customer also preapproves being assessed an amount-exceeding-credit-threshold cost if his credit card account engages in a future amount-exceeding-credit-threshold transaction that exceeds $100 and/or if his credit card account exceeds a credit threshold at the end of the day in which the future amount-exceeding-credit-threshold transaction occurred.

It will be understood that, in this example embodiment, the customer's preapproval is only valid for future amount-exceeding-credit-threshold transactions that exceed $100. In other words, in this embodiment, if the customer engages in a future amount-exceeding-credit-threshold transaction having a transaction amount of $10, the customer's preapproval referred to in block 506 will not be valid for the $10 transaction, the customer cannot be assessed an amount-exceeding-credit-threshold cost associated with the $10 transaction (e.g., in accordance with an amount-exceeding-credit-threshold regulation), and/or the $10 transaction will be declined (unless, of course, the customer provides additional preapproval and/or approval to cover the $10 amount-exceeding-credit-threshold transaction). Also, for simplicity, the predetermined condition placed on the customer's preapproval (i.e., that the preapproval only covers future amount-exceeding-credit-threshold transactions that exceed $100) is sometimes referred to herein as the “predetermined transaction amount condition.”

After the customer enrolls in the amount-exceeding-credit-threshold service and indicates his preapproval, the authorization server 505 stores the customer's preapproval and/or the one or more terms of the predetermined transaction amount condition in a datastore, as represented by block 508. In addition, after enrolling in the amount-exceeding-credit-threshold service, the customer arrives at the POS device 503 to engage in a credit card transaction. As represented by block 510, the customer swipes his credit card at the POS device 503 to initiate a purchase transaction having a $250 transaction amount. Thereafter, the POS device 503 generates and/or sends an authorization request associated with the transaction to the authorization server 505, as represented by block 512. In accordance with some embodiments, the authorization request includes information that, for example, identifies the customer, the credit card account associated with the customer, the amount of the transaction, the one or more goods and/or services involved in the transaction, and/or the like. After receiving the authorization request, the authorization server 505 determines that credit card account involved in the transaction will exceed a credit threshold as a result of the transaction, as represented by block 510. In other words, in some embodiments, the credit card balance will exceed the credit threshold for the credit card if the transaction is completed.

After making the amount-exceeding-credit-threshold determination, the authorization server 505 determines that the customer is enrolled in the amount-exceeding-credit-threshold service provided by the financial institution, as represented by block 516. Thereafter, as represented by block 518, the authorization server 505 determines that the purchase transaction is an amount-exceeding-credit-threshold transaction that satisfies the customer's predetermined transaction amount condition. In other words, in some embodiments, the authorization server 505 determines that customer's preapproval referred to in block 506 covers the purchase transaction referred to in block 510 based at least partially on determining that the purchase transaction is an amount-exceeding-credit-threshold transaction having a transaction amount greater than $100 (i.e., $250 is greater than $100). In some embodiments, the authorization server 505 makes the condition determination based at least partially on comparing the transaction information associated with the purchase transaction to the one or more terms of the customer's predetermined transaction amount condition stored in the datastore. Thereafter, the authorization server 505 approves the authorization request, as represented by block 520, based at least partially on determining that the purchase transaction satisfies the predetermined transaction amount condition, on determining that the customer's preapproval covers the purchase transaction, and/or on determining that the customer indicated his preapproval for future amount-exceeding-credit-threshold transactions that exceed $100. Thereafter, as represented by block 522, the transaction is completed at the POS device 503. In addition, as represented by block 524, the authorization server 505 assesses the customer (and/or the customer's credit card account) an amount-exceeding-credit-threshold cost for exceeding a credit threshold associated with his credit card account. Although not shown, the authorization server 505 can be additionally or alternatively configured to assess the customer an amount-exceeding-credit-threshold cost if the customer's credit card account exceeds a credit threshold at the end of the day in which the transaction occurred.

Of course, the embodiment illustrated in FIG. 5 is merely exemplary and other embodiments may vary without departing from the scope and spirit of the present invention. For example, in some embodiments, one or more portions of the process flow being performed by the authorization server 505 are performed instead by the POS device 503, or vice versa. As another example, in some alternative embodiments of the present invention, instead of involving a credit card account and/or an amount-exceeding-credit-threshold service, the process flow 500 shown in FIG. 5 involves a deposit account, exceeding available funds, and/or an exceeding-available-funds service. As yet another example, in some alternative embodiments, instead of the predetermined condition being tied to the transaction amount of the amount-exceeding-credit-threshold transaction, the predetermined condition is additionally or alternatively tied to the amount the account exceeds a credit threshold as a result of the transaction (e.g., the customer's consent may be valid only for amount-exceeding-credit-threshold transactions that result in his credit card account exceeding a credit threshold by $50 or more, and the like).

Also, in some embodiments, one or more of the portions of the process flow represented by blocks 502-524 are triggered by one or more triggering events, which, in some embodiments, include the performance of one or more of the other portions of the process flow represented by blocks 502-524. Also, in some embodiments, the system 500 is configured to perform the entire process flow represented by blocks 502-524, from start to finish, within moments, seconds, and/or minutes. For example, in some embodiments, the customer consents to the amount-exceeding-credit-threshold amount within approximately 1-5 minutes of the authorization server 505 receiving the authorization request from the POS device 501. Further, it will be understood that one or more portions of the process flow represented by blocks 502-524 are configured to comply with one or more requirements of an amount-exceeding-credit-threshold regulation (e.g., the CARD Act in the United States, and the like).

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, and the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, and the like) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s)

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A method comprising:
receiving, from a holder of an account, consent to a future amount exceeding a credit threshold, wherein the future amount exceeding the credit threshold is a result of a future amount-exceeding-credit-threshold transaction involving the account, and wherein the consent is valid only if a predetermined condition is met;
receiving transaction information associated with a transaction, wherein the transaction involves the account, and wherein the transaction was initiated after the receiving the consent;
determining, using a processor and based at least partially on the transaction information, that the account will exceed the credit threshold as a result of the transaction;
determining that the predetermined condition is met; and
authorizing the transaction based at least partially on the determining that the predetermined condition is met.

2. The method of claim 1, wherein the predetermined condition relates to the future amount-exceeding-credit-threshold transaction, such that the consent is valid only if the future amount-exceeding-credit-threshold transaction is initiated during a predetermined period of time, and wherein the transaction is initiated during the predetermined period of time.

3. The method of claim 1, wherein the predetermined condition relates to the future amount-exceeding-credit-threshold transaction, such that the consent is valid only for a predetermined number of future amount-exceeding-credit-threshold transactions involving the account, and wherein the transaction constitutes an amount-exceeding-credit-threshold transaction that is less than the predetermined number.

4. The method of claim 1, wherein the predetermined condition relates to the future amount exceeding the credit threshold, such that the consent is valid only if the future amount exceeding the credit threshold is greater than a predetermined amount, and wherein the amount exceeding the credit threshold is greater than the predetermined amount.

5. The method of claim 1, wherein the predetermined condition relates to the future amount-exceeding-credit-threshold transaction, such that the consent is valid only if the transaction amount of the future amount-exceeding-credit-threshold transaction is greater than a predetermined amount, and wherein the transaction amount of the transaction is greater than the predetermined amount.

6. The method of claim 1, wherein the predetermined condition relates to the future amount-exceeding-credit-threshold transaction, such that the consent is valid only if the future amount-exceeding-credit-threshold transaction involves a predetermined type of merchant, and wherein the transaction involves the predetermined type of merchant.

7. The method of claim 1, wherein the predetermined condition relates to the future amount-exceeding-credit-threshold transaction, such that the consent is valid only if the future amount-exceeding-credit-threshold transaction involves a predetermined type of channel, and wherein the transaction involves the predetermined type of channel.

8. The method of claim 1, wherein the predetermined condition relates to the future amount-exceeding-credit-threshold transaction, such that the consent is valid only if the future amount-exceeding-credit-threshold transaction involves a merchant associated with a predetermined merchant category code, and wherein the transaction involves a merchant associated with the predetermined merchant category code.

9. The method of claim 1, wherein the predetermined condition relates to the type of the future amount-exceeding-credit-threshold transaction, such that the consent is valid only if the future amount-exceeding-credit-threshold transaction comprises a predetermined transaction type, and wherein the transaction comprises the predetermined transaction type.

10. The method of claim 1, further comprising:
prompting the holder to select the predetermined condition; and
receiving information indicating that the holder has selected the predetermined condition, wherein the receiving the information occurs before the receiving the transaction information.

11. The method of claim 1, further comprising:
determining that the available balance or available credit for the account has fallen below a predetermined threshold; and
prompting the holder to consent to the future amount exceeding the credit threshold based at least partially on the determining that the available balance or available credit has fallen below the predetermined threshold, wherein the prompting the holder occurs before the receiving the consent.

12. The method of claim 1, further comprising:
assessing the account an amount-exceeding-credit-threshold cost based at least partially on determining that the account settled negative at the end of the day in which the transaction occurred; or
determining not to assess the account an amount-exceeding-credit-threshold cost based at least partially on determining that the account settled non-negative at the end of the day in which the transaction occurred.

13. The method of claim 1, further comprising:
receiving, from a second holder of a second account, second consent to a second future amount exceeding a second credit threshold, wherein the second future amount exceeding the second credit threshold is a result of a second future amount-exceeding-credit-threshold transaction involving the second account, and wherein the second consent is valid only if a second predetermined condition is met;
receiving second transaction information associated with a second transaction, wherein the second transaction involves the second account, and wherein the second transaction was initiated after the receiving the second consent;
determining, based at least partially on the second transaction information, that the second account will incur a second amount exceeding the second credit threshold as a result of the second transaction;
determining that the second predetermined condition is not met; and
declining the second transaction based at least partially on the determining that the second predetermined condition is not met.

14. The method of claim 1, further comprising:
storing information associated with the predetermined condition in an account profile associated with the account, wherein the account profile is stored in a datastore, and
wherein the determining that the predetermined condition is met is based at least partially on comparing the transaction information received to the information associated with the predetermined condition in the account profile.

15. An apparatus comprising:
a first communication interface configured to receive, from a holder of an account and via a telecommunications network, consent to a future amount exceeding a credit threshold, wherein the future amount exceeding the credit threshold is a result of a future amount-exceeding-credit-threshold transaction involving the account, and wherein the consent is valid only if a predetermined condition is met;
a second communication interface configured to receive, via a payment network, transaction information associated with a transaction, wherein the transaction involves the account, a transaction machine, and the holder of the account, and wherein the transaction was initiated after the first communication interface receives the consent; and
a processor operatively connected to the first communication interface and the second communication interface, and configured to:
determine, based at least partially on the transaction information, that the account will exceed the credit threshold as a result of the transaction;
determine that the predetermined condition is met; and
authorize the transaction based at least partially on the processor determining that the predetermined condition is met.

16. The apparatus of claim 15, wherein the telecommunications network is a telephone network.

17. The apparatus of claim 15, wherein the predetermined condition relates to the future amount-exceeding-credit-threshold transaction, such that the consent is valid only if the future amount-exceeding-credit-threshold transaction occurs during a predetermined period of time, and wherein the transaction occurs during the predetermined period of time.

18. The apparatus of claim 15, wherein the predetermined condition relates to the future amount-exceeding-credit-threshold transaction, such that the consent is valid only for a predetermined number of future amount-exceeding-credit-threshold transactions involving the account, and wherein the transaction constitutes an amount-exceeding-credit-threshold transaction that is less than the predetermined number.

19. The apparatus of claim 15, wherein the predetermined condition relates to the future amount exceeding the credit threshold, such that the consent is valid only if the amount exceeding the credit threshold is greater than a predetermined amount, and wherein the amount exceeding the credit threshold is greater than the predetermined amount.

20. The apparatus of claim 15, wherein the predetermined condition relates to the future amount-exceeding-credit-threshold transaction, such that the consent is valid only if the transaction amount of the future amount-exceeding-credit-threshold transaction is greater than a predetermined amount, and wherein the transaction amount of the transaction is greater than the predetermined amount.

21. The apparatus of claim 15, wherein the predetermined condition relates to the future amount-exceeding-credit-threshold transaction, such that the consent is valid only if the future amount-exceeding-credit-threshold transaction involves a predetermined type of merchant, and wherein the transaction involves the predetermined type of merchant.

22. The apparatus of claim 15, wherein the predetermined condition relates to the future amount-exceeding-credit-threshold transaction, such that the consent is valid only if the future amount-exceeding-credit-threshold transaction involves a predetermined type of channel, and wherein the transaction involves the predetermined type of channel.

23. The apparatus of claim 15, wherein the predetermined condition relates to the future amount-exceeding-credit-threshold transaction, such that the consent is valid only if the future amount-exceeding-credit-threshold transaction involves a merchant associated with a predetermined merchant category code, and wherein the transaction involves a merchant associated with the predetermined merchant category code.

24. The apparatus of claim 15, wherein the predetermined condition relates to the type of the future amount-exceeding-credit-threshold transaction, such that the consent is valid only if the future amount-exceeding-credit-threshold transaction comprises a predetermined transaction type, and wherein the transaction comprises the predetermined transaction type.

25. The apparatus of claim 15, wherein the first communication interface is further configured to:
prompt the holder, via the telecommunications network, to select the predetermined condition; and
receive information, via the telecommunications network, that indicates that the holder selected the predetermined condition, wherein the first communication interface receives the information before the second communication interface receives the transaction information.

26. The apparatus of claim 15, wherein the processor is further configured to:
determine that the available balance or available credit for the account has fallen below a predetermined threshold; and
instruct the first communication interface to prompt the holder, via the telecommunications network, to consent to the future amount exceeding the credit threshold based at least partially on the processor determining that the available balance or available credit has fallen below the predetermined threshold, wherein the processor instructs the first communication interface to prompt the holder before the first communication interface receives the consent.

27. The apparatus of claim 15, wherein the processor is further configured to assess the account an amount-exceeding-credit-threshold cost based at least partially on processor determining that the account settled negative at the end of the day in which the transaction occurred.

28. The apparatus of claim 15,
wherein the first communication interface is configured to receive, from a second holder of a second account and via the telecommunications network, second consent to a second future amount exceeding a second credit threshold, wherein the second future amount exceeding the second credit threshold is a result of a second future amount-exceeding-credit-threshold transaction involving the second account, and wherein the second consent is valid only if a second predetermined condition is met,
wherein the second communication interface is configured to receive, via the payment network, second transaction information associated with a second transaction, wherein the second transaction involves the second account, a second transaction machine, and the second holder of the second account, and wherein the second transaction was initiated after the first communication interface receives the second consent,
wherein the processor is further configured to:
determine, based at least partially on the second transaction information, that the second account will incur a second amount exceeding the second credit threshold as a result of the second transaction;
determine that the second predetermined condition is not met; and
decline the second transaction based at least partially on the processor determining that the second predetermined condition is not met.

29. The apparatus of claim 15, further comprising:
a memory device operatively connected to the processor and configured to:
store information associated with the predetermined condition in an account profile associated with the account, and
wherein the processor determines that the predetermined condition is met is based at least partially on comparing the transaction information received to the information associated with the predetermined condition in the memory device.

30. A computer program product comprising a non-transitory computer-readable medium, wherein the non-transitory computer-readable medium comprises one or more computer-executable program code portions that, when executed by a computer, cause the computer to:
receive, from a holder of an account, consent to a future amount exceeding a credit threshold, wherein the future amount exceeding the credit threshold is a result of a future amount-exceeding-credit-threshold transaction involving the account, and wherein the consent is valid only if a predetermined condition is met;
receive transaction information associated with a transaction, wherein the transaction involves the account, and wherein the transaction was initiated after the computer receives the consent;
determine, based at least partially on the transaction information, that the account does not have adequate funds or credit to complete the transaction;
determine that the predetermined condition is met; and
provide funds or credit sufficient to complete the transaction based at least partially on the computer determining that the predetermined condition is met.

31. The computer program product of claim 30, wherein the predetermined condition is such that the consent is valid only if the future amount-exceeding-credit-threshold transaction occurs during a predetermined period of time, and wherein the transaction occurs during the predetermined period of time.

32. The computer program product of claim 30, wherein the predetermined condition is such that the consent is valid only for a predetermined number of future amount-exceeding-credit-threshold transactions involving the account, and wherein the transaction constitutes an amount-exceeding-credit-threshold transaction within the predetermined number.

33. The computer program product of claim 30, wherein the predetermined condition is such that the consent is valid only if the transaction amount of the future amount-exceeding-credit-threshold transaction is greater than a predetermined amount, and wherein the transaction amount of the transaction is greater than the predetermined amount.

34. The computer program product of claim 30, wherein the predetermined condition is such that the consent is valid only if the future amount-exceeding-credit-threshold transaction involves a merchant associated with a predetermined merchant category code, and wherein the transaction involves a merchant associated with the predetermined merchant category code.

35. The computer program product of claim 30, wherein the one or more computer-executable program code portions, when executed by the computer, cause the computer to:
prompt the holder to select the predetermined condition; and
receive information associated with the predetermined condition from the holder, wherein the receiving the information occurs before the receiving the transaction information.

36. The computer program product of claim 30, wherein the one or more computer-executable program code portions, when executed by the computer, cause the computer to:
determine that the available balance or available credit for the account has fallen below a predetermined threshold; and
prompt the holder to consent to the future amount exceeding the credit threshold based at least partially on the computer determining that the available balance or available credit has fallen below the predetermined threshold, wherein the computer prompts the holder before the computer receives the consent.

37. The computer program product of claim 30, wherein the one or more computer-executable program code portions, when executed by the computer, cause the computer to:
provide the funds or credit sufficient to complete the transaction by providing only the minimum amount of funds or credit needed to complete the transaction.

38. The computer program product of claim 30, wherein the one or more computer-executable program code portions, when executed by the computer, cause the computer to:
provide the funds or credit sufficient to complete the transaction by crediting the account with the funds or the credit sufficient to complete the transaction.

39. The computer program product of claim 30, wherein the transaction involves a counterparty, and wherein the one or more computer-executable program code portions, when executed by the computer, cause the computer to:
provide the funds or credit sufficient to complete the transaction by providing the counterparty with the funds or credit sufficient to complete the transaction.

40. A method comprising:
receiving, from a holder of an account, preapproval to use an amount-exceeding-credit-threshold service to complete one or more future amount-exceeding-credit-threshold transactions that involve the account, wherein the preapproval is valid only if a predetermined condition is met, and wherein the predetermined condition relates to the one or more future amount-exceeding-credit-threshold transactions such that the preapproval is valid only if the future amount-exceeding-credit-threshold transactions occur during a predetermined period of time;
receiving transaction information associated with a transaction, wherein the transaction involves the account, and wherein the transaction was initiated after the receiving the preapproval;
determining, using a processor and based at least partially on the transaction information, that the account does not have adequate funds or credit to complete the transaction;
determining that the holder's preapproval covers the transaction based at least partially on determining that the transaction has occurred during the predetermined period of time; and
using an amount-exceeding-credit-threshold service to complete the transaction based at least partially on the determining that the holder's preapproval covers the transaction.

41. The method of claim 40, wherein the predetermined period of time comprises the period of time after the holder gave his preapproval and before the end of the day in which the holder gave his preapproval.

42. The method of claim 40, wherein the holder's preapproval covers only a predetermined number of future amount-exceeding-credit-threshold transactions involving the account, and wherein the transaction constitutes an amount-exceeding-credit-threshold transaction that is less than the predetermined number.

43. The method of claim 40, wherein the holder's preapproval covers the one or more future amount-exceeding-credit-threshold transactions only if each of the one or more future amount-exceeding-credit-threshold transactions has a transaction amount greater than a predetermined amount, and wherein the transaction amount of the transaction is greater than the predetermined amount.

44. The method of claim 40, wherein the holder's preapproval covers the one or more future amount-exceeding-credit-threshold transactions only if each of the one or more future amount-exceeding-credit-threshold transactions involves a predetermined type of merchant, and wherein the transaction involves the predetermined type of merchant.

45. The method of claim 40, wherein the holder's preapproval covers the one or more future amount-exceeding-credit-threshold transactions only if each of the one or more future amount-exceeding-credit-threshold transactions comprises a predetermined transaction type, and wherein the transaction comprises the predetermined transaction type.

46. The method of claim 40, further comprising:
prompting the holder to select one or more terms of the holder's preapproval; and
receiving information indicating that the holder has selected one or more terms of the holder's preapproval, wherein the receiving the information occurs before the receiving the transaction information.

47. The method of claim 40, further comprising:
determining that the available balance or available credit for the account has fallen below a predetermined threshold; and
prompting the holder to preapprove using an amount-exceeding-credit-threshold service to complete the one or more future amount-exceeding-credit-threshold transactions, wherein the prompting the holder occurs before the receiving the holder's preapproval.
